(19) United States
(12) Patent Application Publication
(10) Pub. No.: US 2012/0003009 A1
(43) Pub. Date: Jan. 5, 2012

(54) IMAGE FORMING APPARATUS

(75) Inventors: Toshifumi Kitamura, Numazu-shi (JP); Teruhiko Namiki, Mishima-shi (JP)

(73) Assignee: CANON KABUSHIKI KAISHA, Tokyo (JP)

(21) Appl. No.: 13/165,007

(22) Filed: Jun. 21, 2011

(30) Foreign Application Priority Data
Jun. 30, 2010 (JP) 2010-150104
Feb. 2, 2011 (JP) 2011-020807
Apr. 1, 2011 (JP) 2011-081948

(51) Int. Cl. G03G 15/00

(52) U.S. Cl. 399/167

(57) ABSTRACT

The image forming apparatus is capable of preventing operation noise of a drive part from increasing in performing phase adjustment of an image bearing member, reducing consumption power, or achieving a reduction in motor specifications. Based on a rotation phase of a photosensitive drum (1K) detected by a phase detection sensor and a rotation phase of another photosensitive drum detected by a phase detection sensor, a CPU performs the phase adjustment by reducing a rotation speed of a motor (C) that is driving the another photosensitive drum so as to achieve a predetermined phase relationship, and causes an image forming unit to form an image after the phase adjustment is finished.

### BACKGROUND OF THE INVENTION

1. Field of the Invention

The present invention relates to a color image forming apparatus using an electrophotographic process, such as a laser printer, a copier, or a facsimile machine including a plurality of photosensitive members.

2. Description of the Related Art

In recent years, color image forming apparatuses of an in-line system are more often used as the speed of image formation increases. In the image forming apparatus of the in-line system, light beams are independently scanned across plural photosensitive drums by plural optical devices, and toner images in respective colors are formed by plural developing devices. The toner images in the respective colors are superposed on an intermediate transferring belt and then transferred onto a transfer material, or are transferred onto the transferring material on a transferring belt so as to be superposed one on another. However, in the in-line system, the plural photosensitive drums and the plural optical devices are used, and hence color deviation of toner in four colors (yellow (Y), magenta (M), cyan (C), and black (K)) is more likely to occur than in a four-pass system. Therefore, in order to resolve the color deviation (color deviation of AC components) that changes cyclically due to eccentricity of a gear for driving the respective photosensitive drums or non-uniform rotational speed of the motor, a structure for reducing relative color deviation by controlling the respective photosensitive drums to maintain a desired relationship in rotation phases thereof. For example, in Japanese Patent Application Laid-Open No. 2005-128052, phases of the respective photosensitive drums are adjusted so as to have a desired phase relationship during a period after the respective photosensitive drums are activated and before an actual image forming operation is started.

However, as in Japanese Patent Application Laid-Open No. 2005-128052, the following problem arises in a case where the phases of the respective photosensitive drums are adjusted immediately before actual image formation is performed. That is, the time period to perform a phase adjustment is restricted in terms of a first print out time (FPOT) because the phase adjustment is performed just before the image formation is performed. This can be handled by sharply changing amounts of rotation speeds of motors that are driving the respective photosensitive drums in performing the phase adjustment. However, various problems may arise in a case where, for example, the rotation speed of the motor for driving a photosensitive drum, and that is, the acceleration of the motor is increased in order to cause the rotation phase of a given photosensitive drum to further advance a rotation phase in a photosensitive drum. For example, there is a problem of operation noise. Rotation control of a motor is performed by switching a direction of a current to be caused to flow through a coil provided to the motor, which causes electromagnetic noise. When the rotation speed of the motor becomes higher, a speed of the current switching becomes higher accordingly, and a frequency of the electromagnetic noise also becomes higher, which may be uncomfortable for a user. In addition, even without the problem of the noise of the motor itself, a drive force is transmitted from the motor to the photosensitive drum through a chain of gears, and hence the operation noise that occurs due to engagement of the gears increases as the rotation speed of the motor increases. Further, for example, there is a problem of power consumption. Power consumed by the motor is proportional to the rotation speed if a load torque is constant. That is, when the rotation speed of the motor is increased in the phase adjustment, the power consumed by the motor itself increases accordingly. In addition, for example, there is a problem of motor specifications. A torque of the motor that can be output decreases as the rotation speed thereof increases. That is, it is necessary to design the motor on the assumption that the rotation speed of the motor is increased in the phase adjustment, which may lead to an increase in cost resulting from an increase in the motor specifications.

### SUMMARY OF THE INVENTION

The purpose of the present invention is to solve at least one of the above-mentioned problems and other problems.

Another purpose of the present invention is to achieve preventing operation noise of a drive part from increasing in performing phase adjustment of an image bearing member, reducing power consumption or reducing requirement for motor specifications.

A further purpose of the present invention is to provide an image forming apparatus, including a plurality of image bearing members, motors that drive the plurality of image bearing members, a detector that detects rotation phases of the plural image bearing members, a controller that starts driving the plurality of image bearing members according to a printing instruction from an external computer and performs phase adjustment for controlling rotations of the motors so that the rotation phases of the plurality of image bearing members achieves a predetermined phase relationship based on the detected rotation phases of the plurality of image bearing members during a period after the drive of the plurality of image bearing members is started and before an image forming operation is performed, and an image forming unit that forms an image on each of the plurality of image bearing members based on image data transmitted from the external computer after the phase adjustment is performed by the controller, wherein based on a rotation phase of an image bearing member as a reference among the plurality of image bearing members whose rotation phase is detected by the detector and a rotation phase of another image bearing member except the image bearing member as the reference, the controller performs the phase adjustment to achieve the predetermined phase-relationship by reducing a rotation speed of a motor that drives the another image bearing member except the image bearing member, so that the image forming unit forms the image after the phase adjustment is finished.

Further features of the present invention will become apparent from the following description of exemplary embodiments with reference to the attached drawings.

### BRIEF DESCRIPTION OF THE DRAWINGS

FIG. 1A is a schematic diagram of an image forming apparatus for the first embodiment.

FIG. 1B is a drive circuit diagram of a DC brushless motor for the first embodiment.

FIG. 2A is a table showing drive control of the DC brushless motor for the first embodiment.

FIG. 2B is a front view and a side view that illustrate a rotation phase detection mechanism of a photosensitive drum for the first embodiment.

FIG. 2C is a drive control block diagram of the DC brushless motor for the first embodiment.

FIG. 3 is a front view illustrating a drive structure of the photosensitive drums for the first embodiment.

FIGS. 4A and 4B are timing charts illustrating phase detection and phase adjustment of the photosensitive drums for the first embodiment.

FIG. 5 is a flowchart illustrating a phase adjustment processing prior to printing for the first embodiment.

FIG. 6 is a timing chart illustrating operations for the phase detection and the phase adjustment for the second embodiment.

FIG. 7 is a timing chart illustrating operations for the phase detection and another phase adjustment for the third embodiment.

FIGS. 8A, 8B, and 8C are diagrams illustrating another drive structure of the photosensitive drums, a relationship between a photosensitive drum diameter and distances between the photosensitive drums, and a phase relationship among the photosensitive drums for the fourth embodiment.

FIGS. 9A, 9B, and 9C are timing charts illustrating operations for phase detection and another phase adjustment for the fourth embodiment.

FIGS. 10A, 10B, and 10C are tables illustrating stop timings and activation timings of the photosensitive drums for the fourth embodiment.

FIGS. 11A and 11B are flowcharts illustrating processings performed when photosensitive drums are stopped and activated for the fourth embodiment.

FIGS. 12A and 12B are timing charts illustrating phase detection and another phase adjustment of the photosensitive drums for the fifth embodiment.

FIG. 13 is for the fourth embodiment a flowchart illustrating a phase adjustment processing prior to printing for the fifth embodiment.

FIGS. 14A and 14B are timing charts illustrating another phase detection of the photosensitive drums for the sixth embodiment.

FIG. 15 is a flowchart illustrating another phase adjustment processing prior to printing for the sixth embodiment.

FIGS. 16A, 16B, 16C, and 16D are timing charts illustrating phase detection of the photosensitive drums for the sixth embodiment.

FIGS. 17A and 17B are a flowchart illustrating another phase adjustment processing prior to printing for the seventh embodiment.

FIGS. 18A and 18B are timing charts illustrating operations for another phase detection and another phase adjustment for the eighth embodiment.

FIGS. 19A and 19B are timing charts illustrating operations for phase detection and another phase adjustment for the ninth embodiment.

### DESCRIPTION OF THE EMBODIMENTS

Hereinafter, a mode for carrying out the present invention is described in detail with reference to embodiments of the present invention.

(Structure of an Image Forming Apparatus)

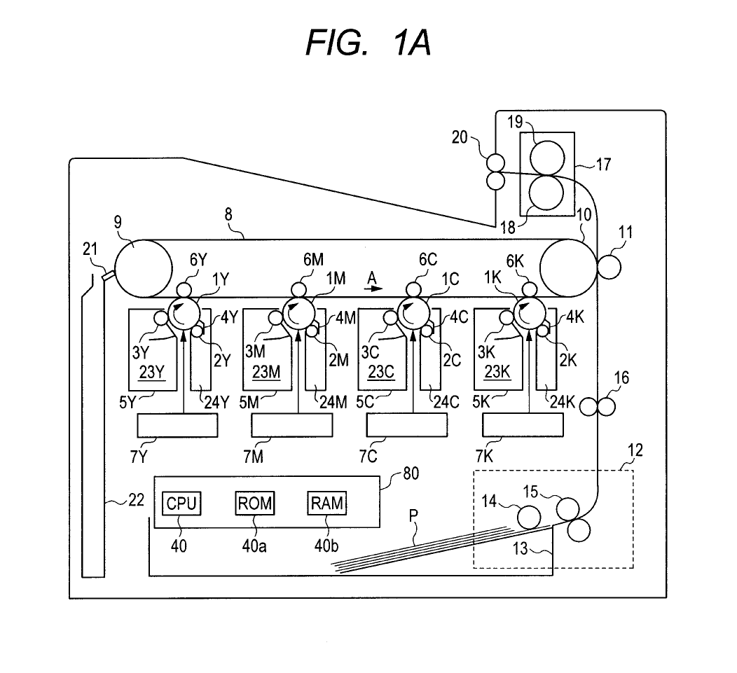

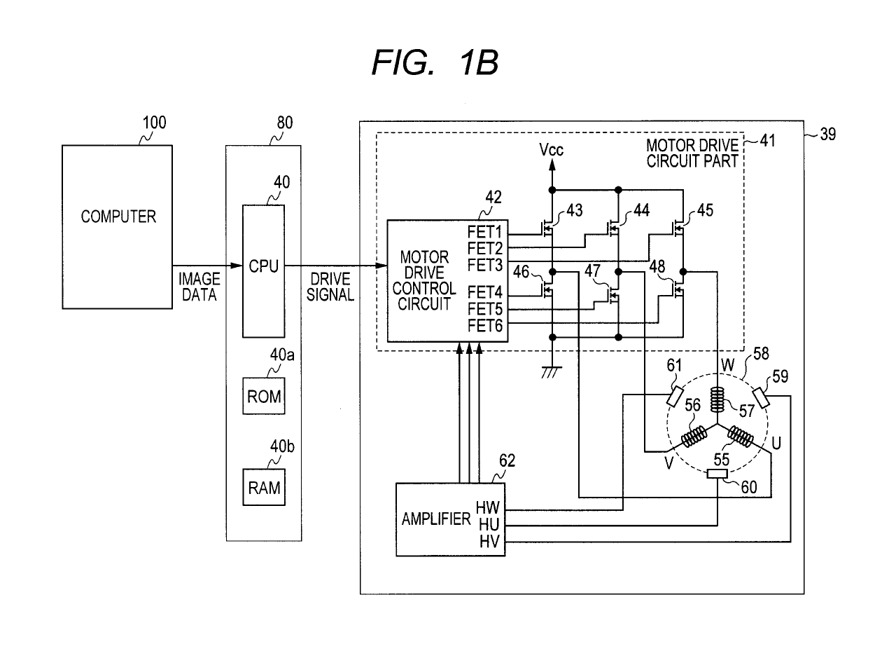

First, a first embodiment of the present invention is described. A color image forming apparatus (hereinafter, referred to as “main body”) illustrated in FIG. 1A includes process cartridges 5Y, 5M, 5C, and 5K that are detachably attached to the main body. The four process cartridges 5Y, 5M, 5C, and 5K have the same structure but are different in that images are formed by using toner in different colors of yellow (Y), magenta (M), cyan (C), and black (K). Hereinafter, reference symbols Y, M, C, and K are omitted except for cases where the respective colors are described independently. The process cartridges 5 each include a toner container 23, a photosensitive drum 1 being an image bearing member, a charge roller 2, a developing roller 3, a drum cleaning blade 4, and a waste toner container 24. A laser unit 7 is located below the photosensitive drum 1, and performs exposure based on an image signal on the photosensitive drum 1. Here, the image signal is a signal according to image data supplied from an external computer 100. The photosensitive drum 1 is charged to a predetermined negative-polarity potential by the charge roller 2, and then has an electrostatic latent image formed thereon by the laser unit 7. The electrostatic latent images are each subjected to reversal development by the developing roller 3 and have negative-polarity toner adhered thereto, thereby forming toner images in Y, M, C, and K. By the laser unit 7 and the developing roller 3 for the respective colors, images are formed on the photosensitive drums for the respective colors. An intermediate transferring belt unit includes an intermediate transferring belt 8, a drive roller 9, and a secondary transfer opposing roller 10. Primary transferring rollers 6 are disposed inside the intermediate transferring belt 8 so as to be opposed to the respective photosensitive drums 1, and each have a transfer bias applied thereto by a bias applying device (bias applying unit) (not shown). The toner images formed on the photosensitive drums 1 are primarily transferred onto the intermediate transferring belt 8 in order from the toner image on the photosensitive drum 1Y by causing the respective photosensitive drums 1 to rotate in the arrow direction, causing the intermediate transferring belt 8 to revolve in a direction indicated by the arrow A, and applying a positive-polarity bias to the primary transferring rollers 6. The image having the four color toner images superposed one on another is transported on the intermediate transferring belt 8 to a secondary transferring roller 11.

A sheet feed/transport apparatus 12 includes a sheet feed roller 14 for feeding a transferring material P from a sheet feed cassette 13 for accommodating the transferring material P and a transport roller pair 15 for transporting the fed transferring material P. The transferring material P transported from the sheet feed/transport apparatus 12 is transported to the secondary transferring roller 11 by a registration roller pair 16. The secondary transferring roller 11 has a positive-polarity bias applied thereto, and the four-color toner image on the intermediate transferring belt 8 is secondarily transferred onto the transported transferring material P. The transferring material P that has been subjected to the transfer of the toner image is transported to a fixing device 17, is heated and pressurized by a fixing film 18 and a pressure roller 19, and has the toner image fixed on a surface thereof. The transferring material P on which the color image has been fixed is delivered by a delivery roller pair 20. On the other hand, toner remaining on surfaces of the photosensitive drums 1 after the transfer of the toner images is removed by the drum cleaning blades 4. Further, toner remaining on the intermediate transferring belt 8 after the secondary transfer onto the transferring material P is removed by a transferring belt cleaning blade 21, and the removed toner is collected in a waste toner collecting container 22.

A control board 80 mounted with an electric circuit for controlling the main body includes a CPU 40, a ROM 40a, and a RAM 40b. The CPU 40 collectively controls operations of the main body by control programs stored in the ROM 40a in terms of control of a drive source (not shown) related to the transport of the transferring material P and a drive source (not shown) for the process cartridges, control related to the image formation, control related to failure detection, and the like. Further, when a printing instruction is received along with the image data from the external computer 100 through a communication line, the CPU 40 of the control board 80 supplies the image signal according to the supplied image data to the laser unit 7. The RAM 40b temporarily retains data on the control performed by the CPU 40, and is also used as a work area for a calculation processing involved in the control. Note that, the control board 80 including the CPU 40 is merely an example as a controller, and is not limited to this mode as the controller. For example, an application-specific integrated circuit (ASIC) may be caused to perform a part or all of the processings performed by the CPU 40. Alternatively, another CPU may be provided to be caused to perform a part of the processings performed by the CPU 40.

(DC Brushless Motor)

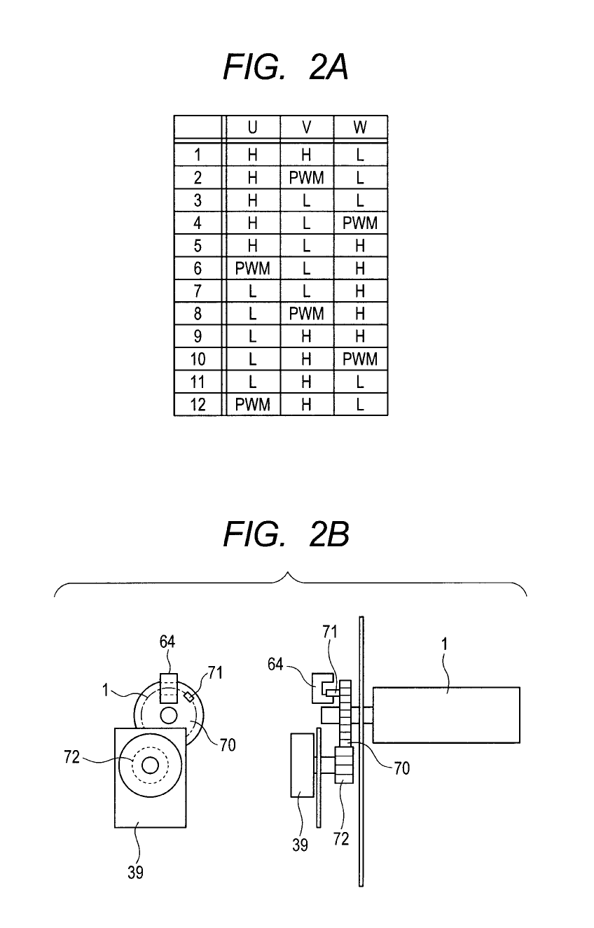

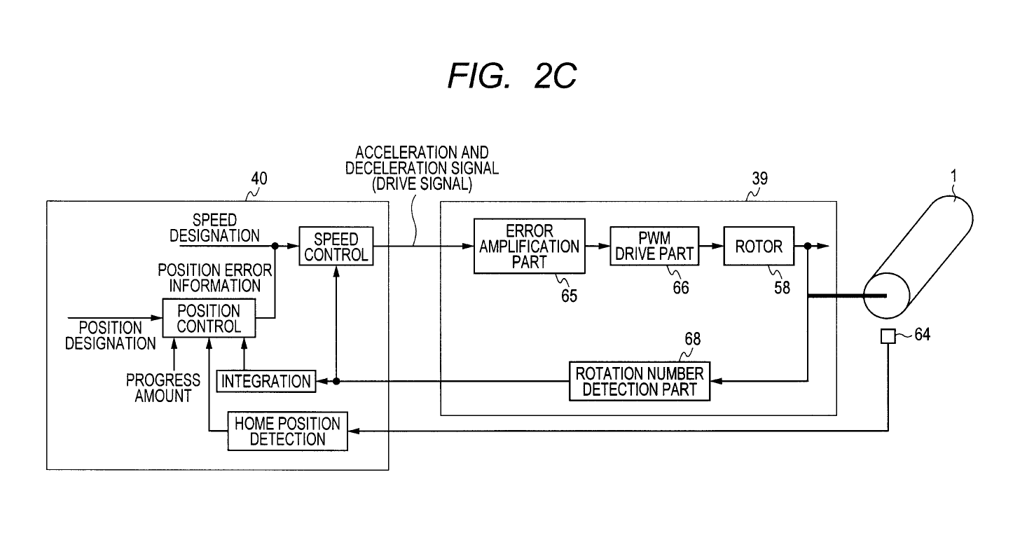

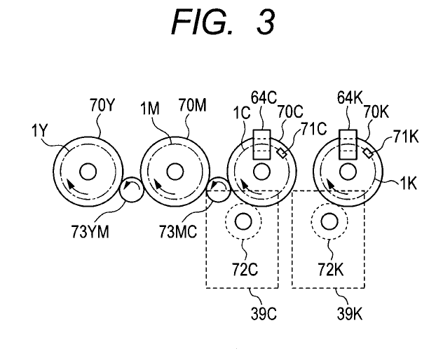

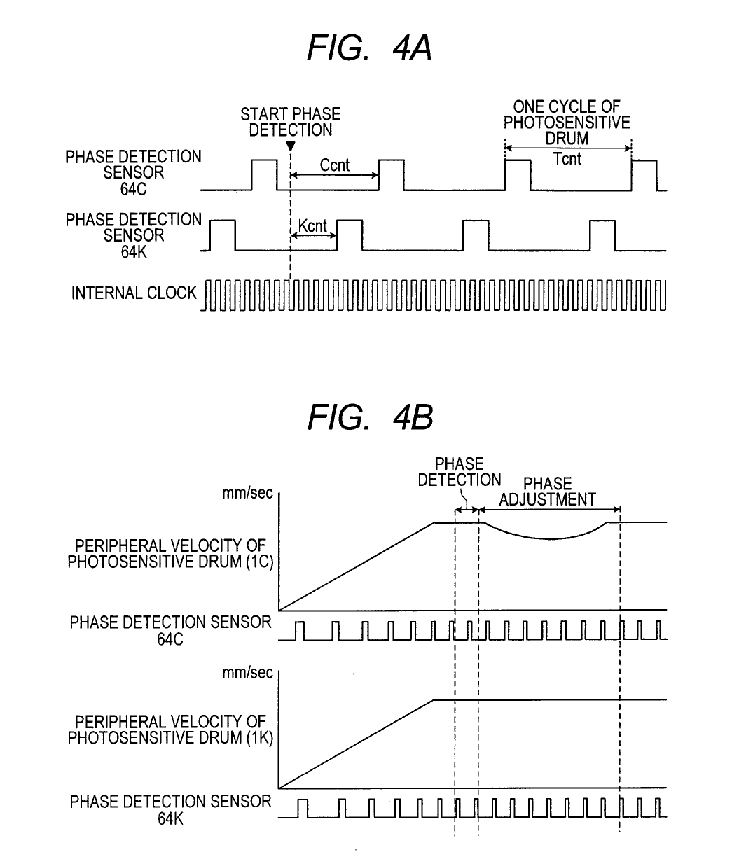

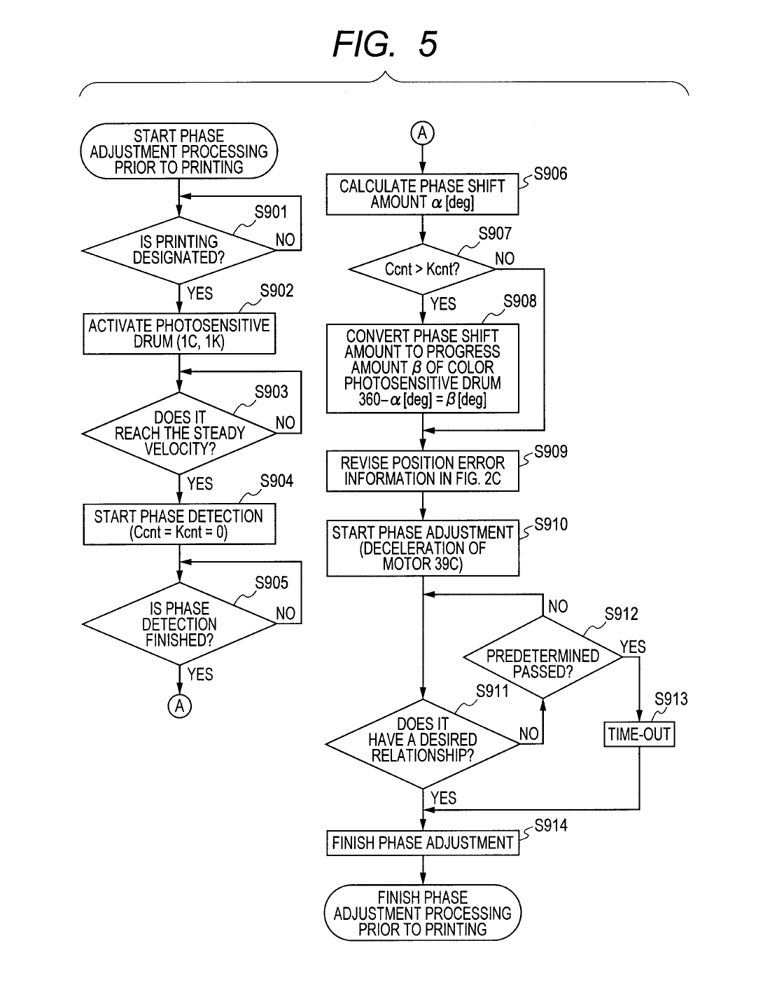

A DC brushless motor being a drive source for the photosensitive drum 1 is described. FIG. 1B is a drive circuit structure diagram of the DC brushless motor (hereinafter, referred to as “motor 39”), which includes Y-connected coils 55 to 57, a rotor 58, and Hall elements 59 to 61 serving as a position detecting unit for the rotor 58. The Hall elements 59 to 61 are each an element that generates a voltage across both ends of a semiconductor piece upon detection of a magnetic field, thereby enabling a position of the rotor 58 to be detected. Outputs from the Hall elements 59 to 61 are input to ports HV, HU, and HW, respectively, of an amplifier 62 to be amplified, and then input to a motor drive control circuit 42. A motor drive circuit part 41 includes: the motor drive control circuit 42; and high-side FETs 43 to 45 and low-side FETs 46 to 48 that are controlled by signals output from ports FET1 to FET6 of the motor drive control circuit 42. The high-side FETs 43 to 45 and the low-side FETs 46 to 48 are connected to one ends U, V, and W of the coils 55 to 57, respectively, and are subjected to on/off control according to a phase switching signal output from the motor drive control circuit 42, to cause the rotor 58 to rotate by sequentially switching the phase to be excited. The phase switching signal is generated by the motor drive control circuit 42 detecting a drive signal from an output port of the CPU 40 and a position signal of the rotor 58 generated from the Hall elements 59 to 61. For the rotation of the motor 39 related to the phase switching, employed is a principle that the motor 39 is caused to rotate when respective phases (U phase, V phase, and W phase) are sequentially excited by switching over potentials at U, V, and W in the order illustrated in FIG. 2A.

FIG. 2B illustrates the motor 39 and a rotation phase detection mechanism of the photosensitive drum 1. A gear 70 rotates integrally with the photosensitive drum 1, and drives the photosensitive drum 1. A flag 71 is provided to the gear 70 so as to block an optical path of a photo sensor 64 while the photosensitive drum 1 is rotating. Accordingly, each time the photosensitive drum 1 rotates one turn, a signal is output from the photo sensor 64 (hereinafter, referred to as “phase detection sensor 64”). Further, an output shaft of the motor 39 is provided with a gear 72, and a drive force is transmitted from the motor 39 to the photosensitive drum 1 by bringing the gear 72 and the gear 70 into engagement with each other.

FIG. 2C is a control block diagram related to speed control of the rotation of the motor 39. Here, in order to perform the speed control, for example, the CPU 40 compares rotation speed information with a rotation speed target value (speed designation in FIG. 2C) prestored in the ROM 40a, and obtains speed error information. Further, in order to perform position control, for example, the CPU 40 compares position information on the rotor 58, which is obtained by integrating the rotation speed information, with a position target value (position designation in FIG. 2C) prestored in the ROM 40a, and obtains position error information. The CPU 40 calculates a motor operation amount from the speed error information and the position error information, and outputs an acceleration and deceleration signal serving as the drive signal to the motor 39. The acceleration and deceleration signal output from the CPU 40 to the motor 39 is amplified by an error amplification part 65, and is output to a PWM drive part 66. The PWM drive part 66 PWM-drives the FETs 43 to 48 of the motor drive circuit part 41, and causes the rotor 58 to rotate. Note that, the error amplification part 65 and the PWM drive part 66 are included in the motor drive control circuit 42. Further, a rotation number of the rotor 58 is detected by a rotation number detection section 68 (not shown in FIG. 2B), and the detected result is fed back to the CPU 40 so as to be used for the speed control as the rotation speed information or used for the position control as the position information after being integrated. In other words, the rotation number detection section 68 outputs an FG signal to the CPU 40, and the CPU 40 detects a flank of the FG signal and uses the detected result for the speed control or uses the detected result for the position control after integration thereof. The output from the phase detection sensor 64 is fed back to the CPU 40 as information on home position detection used for the position control performed by the CPU 40. In addition, a lead amount described later is used for the position control.

Next, FIG. 3 is referenced to describe a drive structure of the photosensitive drum 1 according to this embodiment. In this embodiment, the description is given assuming that the photosensitive drums 1Y, 1M, 1C, and 1K are driven by, for example, two motors (for example, for color and for black). FIG. 3 illustrates a structure in which the photosensitive drums 1Y, 1M, and 1C for color and the photosensitive drum 1K for black are being driven by gears 72C and 72K provided to motors 39C and 39K, respectively. Here, the number of teeth of each of gears 73YM and 73MC provided between gears 70Y, 70M, and 70C for driving the photosensitive drums 1Y, 1M, and 1C has an integer ratio to the number of teeth of each of the gears 70Y, 70M, and 70C. Note that, rotation phases of the photosensitive drums 1Y, 1M, and 1C are assumed to be the same all the time. Therefore, as the photo sensor and the flag for detecting the rotation phase of the photosensitive drum 1, only two phase detection sensors 64C and 64K and two flags 71C and 71K are provided in the same manner. Further, in this embodiment, a state in which output timings of the signals from the phase detection sensors 64 for the respective photosensitive drums 1 match one another is assumed to be a desired phase relationship that can suppress the color deviation of AC components (color deviation that changes cyclically). Alternatively, the respective photosensitive drums may be arranged so as to assume a case where the output timings of the phase detection sensors 64 for the respective photosensitive drums 1 have a predetermined shift as the desired phase relationship that can suppress the color deviation of AC components.

(Phase Shift Amount)

Next, FIG. 4A is referenced to describe a rotation phase detection method for the photosensitive drums 1 according to this embodiment. FIG. 4A illustrates waveforms of the output signals from the phase detection sensors 64C and 64K for detecting the rotation phases of the photosensitive drums 1 and a waveform of an internal clock generated inside the CPU 40. The CPU 40 starts phase detection at an arbitrary timing after a peripheral velocity of the photosensitive drum 1 reaches a steady-state speed. The CPU 40 starts count operations (Ccnt and Kcnt) in synchronization with the internal clock at a timing when the phase detection is started (indicated by the vertical broken line), and stops the count operation when ascending flanks of the output signals from the phase detection sensors 64C and 64K are detected. The CPU 40 prestores a count value (Tcnt: photosensitive drum cycle) obtained when the photosensitive drum 1 rotates one turn in, for example, the RAM 40b. Note that, the count value (Tcnt: photosensitive drum cycle) obtained when the photosensitive drum 1 rotates one turn may be measured as necessary or may be prestored. The CPU 40 can detect a relative phase shift (lead or delay) amount based on the photosensitive drum cycle Tcnt and the count values Ccnt and Kcnt obtained when the ascending flanks of the output signals from the phase detection sensors 64C and 64K are detected after the start of the phase detection. For example, if Ccnt>Kcnt is satisfied in FIG. 4A, a shift amount (hereinafter, referred to as “phase shift amount”) between the rotation phases of the photosensitive drums 1C and 1K is (Ccnt−Kcnt)/(Tcnt)×360 (deg). For example, assuming that Ccnt=520, Kcnt=260, and Tcnt=720, the phase shift amount is 130 (deg). In other words, the phase of the photosensitive drum 1K (image bearing member serving as a reference among plural image bearing members) leads the phase of the photosensitive drum 1C (another image bearing member other than the image bearing member serving as the reference) by 130 (deg). In other words, the phase of the photosensitive drum 1C is delayed behind the phase of the photosensitive drum 1K by 130 (deg).

(Phase Adjustment)

Next, FIG. 4B is referenced to describe a phase adjustment method for the photosensitive drums 1 according to this embodiment. Hereinafter, the photosensitive drums 1Y, 1M, and 1C for color are represented by the photosensitive drum 1C for color. FIG. 4B illustrates relationships between the peripheral velocities (mm/sec) of the photosensitive drums 1C and 1K and the output signals from the phase detection sensors 64C and 64K, respectively. Rotation phase detection described with reference to FIG. 4A is performed when the peripheral velocities of the photosensitive drums 1C and 1K reach the steady-state speed (steady-state rotation speed) after the photosensitive drums 1C and 1K are activated. A rotation phase detection period is defined by the two vertical broken lines (left and middle) in FIG. 4B. In this embodiment, with the rotation phase of the photosensitive drum 1K set as a reference, the CPU 40 converts the result of the rotation phase detection into a phase lead amount of the rotation phase of the photosensitive drum 1C with respect to the rotation phase of the photosensitive drum 1K. For example, in FIG. 4A, with the rotation phase of the photosensitive drum 1K set as the reference, the rotation phase of the photosensitive drum 1C is delayed by 130 (deg), and hence a phase delay amount of the photosensitive drum 1C is converted into a phase lead amount of 360−130=230 (deg). The phase lead amount (lead amount in FIG. 2C) is used for the position control performed by the CPU 40. The CPU 40 uses a result of the conversion for the speed control inside the CPU 40 as the position error information described above. As a result, the CPU 40 adjusts the rotation phases of the photosensitive drums 1C and 1K by outputting the drive signal (deceleration signal) to the motor 39C and reducing a rotation speed of the motor 39C. Note that, hereinafter, the wording “reducing the motor 39” means outputting the deceleration signal to the motor 39C based on an instruction issued from the CPU 40. Accordingly, is possible to reduce an increase in operation noise generated by accelerating the rotation speed of the motor 39C for the photosensitive drum 1C, power consumption of the motor 39C itself, and an increase in cost resulting from an increase in the motor specifications.

(Phase Adjustment Processing (Phase Control Processing))

The flowchart of FIG. 5 is referenced to describe a flow of a phase adjustment processing prior to printing according to this embodiment. When the CPU 40 determines that there is a printing instruction received from the external computer 100 or the like in Step S901 (hereinafter, “Step” is referred to as “S”), the CPU 40 starts (activates) driving of the photosensitive drums 1C and 1K by the motors 39C and 39K in S902. Note that, here, the printing instruction is accompanied by the image data supplied from the external computer 100. When the CPU 40 determines that the peripheral velocities of the photosensitive drums 1C and 1K have reached the steady-state speed in S903, the CPU 40 starts the phase detection by the phase detection sensors 64C and 64K in S904. In this case, the CPU 40 clears the count values Ccnt and Kcnt for the phase detection (Ccnt=Kcnt=0). Then, the CPU 40 executes the phase detection by the phase detection sensors 64C and 64K as described above. When the CPU 40 determines that the phase detection has been finished in S905, the CPU 40 calculates a phase shift amount α (deg) (predetermined amount) based on results of the detection by the phase detection sensors 64C and 64K in S906. Note that, the phase shift amount α (deg) is obtained by, for example, calculating the shift amount of the rotation phase of the photosensitive drum 1C with the rotation phase of the photosensitive drum 1K set as the reference (α=(Ccnt−Kcnt)/(Tcnt)×360 (deg)). In S907, the CPU 40 compares the count values Ccnt and Kcnt for the phase detection with each other. If the CPU 40 determines that Ccnt>Kcnt is satisfied (that the photosensitive drum 1C is delayed behind the photosensitive drum 1K by the phase shift amount α (delayed by a predetermined amount)), the CPU 40 performs the processing of S908. In S908, the CPU 40 converts the phase shift amount a (in this case, α represents a delay amount) between the photosensitive drums 1C and 1K into a lead amount β (=360−α (deg)) of the phase of the photosensitive drum 1C with respect to the photosensitive drum 1K.

On the other hand, when the CPU 40 determines that Ccnt>Kcnt is not satisfied (that the photosensitive drum 1C leads the photosensitive drum 1K) in S907, the phase shift amount α is a lead amount, and hence the CPU 40 advances to the processing of S909 without the conversion. In S909, the CPU 40 revises the position error information by using the calculated phase shift amount α (if CcntKcnt, a being a lead amount) or the lead amount β (if Ccnt>Kcnt) for the position control as illustrated in FIG. 2C. In S910, the CPU 40 starts phase adjustment based on the revised position error information. In other words, the CPU 40 starts the phase adjustment in order to cause a revised position error to become zero. In the phase adjustment, the CPU 40 reduces the rotation speed of the motor 39C that is driving the photosensitive drum 1C because the rotation phase of the photosensitive drum 1C leads that of the photosensitive drum 1K as the reference. In S911, the CPU 40 continuously executes the phase adjustment until the CPU 40 determines that the phases of the respective photosensitive drums have achieved the desired phase relationship. Further, the CPU 40 keeps executing the phase adjustment until the CPU 40 determines that a time required for the phase adjustment has exceeded a predetermined time in S912 and a time-out occurs in S913. After YES is determined in S911, or after S913 is performed, the phase adjustment is finished in S914. Then, after the phase adjustment is finished, the CPU 40 finishes the phase adjustment processing prior to printing, and advances to an actual printing operation (image forming operation). Note that, the CPU 40 determining that the predetermined time has been exceeded in S912 and the time-out occurring in S913 are set in order to prevent the image forming operation from starting later than necessary due to a long time required for the phase adjustment.

Note that, in this embodiment, as illustrated in the flowchart of FIG. 5, the phase detection is carried out after the photosensitive drums (1C and 1K) reach the steady-state speed. However, the timing to start the phase detection may naturally be a timing before the photosensitive drums (1C and 1K) reach the steady-state speed.

As described above, according to this embodiment, it is possible to realize any one of the following: preventing operation noise of the motor 39 from increasing in the phase adjustment of the photosensitive drum 1; reducing consumption power; and achieving a reduction in the motor specifications.

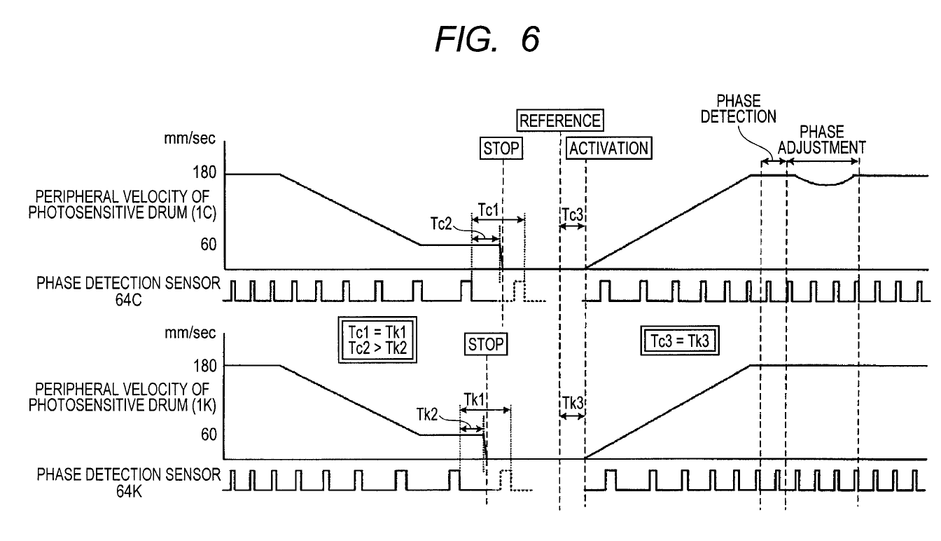

Next, a second embodiment of the present invention is described. The second embodiment is the same as the first embodiment in terms of the operation related to the phase detection and the phase adjustment, and relates to control of activation and stopping of the photosensitive drums 1C and 1K. In the same manner as in the first embodiment, the description of this embodiment is given assuming that the photosensitive drums 1Y, 1M, 1C, and 1K are driven by the two motors (for color and for black). Further, in the same manner as in the first embodiment, it is assumed that the rotation phases of the photosensitive drums 1Y, 1M, and 1C for color are the same all the time, and that the state in which the output timings of the signals from the phase detection sensors 64C and 64K for the respective photosensitive drums 1 match each other is the desired phase relationship that can suppress the color deviation of AC components. In this embodiment, stopping phases of the respective photosensitive drums 1C and 1K are shifted, and the next activation of the photosensitive drums 1C and 1K is performed simultaneously. FIG. 6 is referenced to describe an actual operation according to this embodiment.

(Stopping and Activation of Photosensitive Drums)

FIG. 6 illustrates relationships between the peripheral velocities (mm/sec) of the photosensitive drums 1C and 1K and the output signals from the phase detection sensors 64C and 64K in cases of stopping and activating the photosensitive drums 1C and 1K, respectively. In FIG. 6, when the photosensitive drums 1C and 1K that are rotating at a peripheral velocity of 180 mm/sec are to be stopped, the rotation speed is temporarily reduced down to a peripheral velocity of 60 mm/sec. When the peripheral velocities of the respective photosensitive drums 1C and 1K become 60 mm/sec (Tc1=Tk1), with falling signal flanks of the respective phase detection sensors 64C and 64K set as references, the photosensitive drums 1C and 1K are caused to stop at stop timings Tc2 and Tk2 (msec), respectively. With the stop timings satisfying a relationship of Tc2>Tk2, the photosensitive drum 1K is first stopped, and hence the phase of the photosensitive drum 1C leads when the photosensitive drum 1C is stopped. The phase lead amount can be set by the timings Tc2 and Tk2. For example, the timings Tc2 and Tk2 may be set to satisfy Tc2−Tk2=65 (msec) assuming that each photosensitive drum diameter is φ30 (mm), the peripheral velocity is 60 (mm/sec), and the phase lead amount of the photosensitive drum 1C is 15°. Here, the phase lead amount is set within a range from 0° to 180°. The phase lead amount is set from 0° to 180° for the following reason. That is, for example, if the phase lead amount of the photosensitive drum 1C is 330° (>180°), there is a fear that the time required for deceleration corresponding to the phase lead amount of 330° may be longer than the time required for acceleration corresponding to a phase delay amount of 30° (=360°−330°). This impairs the advantage in reducing the motor 39.

Then, after the photosensitive drum 1 is stopped, activation timings Tc3 and Tk3 after a reference timing are set to be the same (Tc3=Tk3) when the respective photosensitive drums 1C and 1K are activated subsequently (hereinafter, referred to as “next”). However, in a case where a sufficient power capacity is not secured for the image forming apparatus at the activation, when the peripheral velocities of the photosensitive drums reach steady-state rotation, the activation timing of one of the photosensitive drums may be shifted by a time required to cause the photosensitive drum to rotate by 360°. With this arrangement, when the motors 39 reach a rotation speed used for image formation, it is possible to activate the respective photosensitive drums while maintaining a phase difference between the photosensitive drums created at the stopping. Accordingly, it is possible to maintain a phase relationship between the respective photosensitive drums 1C and 1K (in which the phase of the photosensitive drum 1C leads the photosensitive drum 1K). After the respective photosensitive drums 1C and 1K are activated, in the same manner as in the first embodiment, the phase detection and the phase adjustment are performed when the peripheral velocities of the photosensitive drums 1C and 1K reach the steady-state speed. In this embodiment, the phase of the photosensitive drum 1C leads (Ccnt<Kcnt), and hence it is unnecessary to perform the processing of S908 in FIG. 5. Then, if the flowchart of FIG. 5 is executed after performing the above-mentioned activation, the CPU 40 determines NO in S907 and performs control to reduce the rotation speed of the motor 39C that is driving the photosensitive drum 1C to thereby perform the phase adjustment.

Note that, in this embodiment, if the phase relationship between the respective photosensitive drums 1C and 1K is not the desired phase relationship in an initial state such as a power-on time, it is possible to stop the rotation with the desired phase relationship. In other words, if the respective photosensitive drums 1C and 1K are driven by an initial operation executed thereafter, the stopping can be then controlled to stop the rotation with the desired phase relationship. That is, after the execution of the initial operation, the desired phase relationship can be continuously maintained as the phase relationship between the respective photosensitive drums by the control of the activation/stopping described in this embodiment (the same applies to the following third and fourth embodiments of the present invention).

As described above, according to this embodiment, it is possible to realize any one of the following: preventing operation noise of the motor 39 from increasing in the phase adjustment of the photosensitive drum 1; reducing consumption power; and achieving a reduction in the motor specifications.

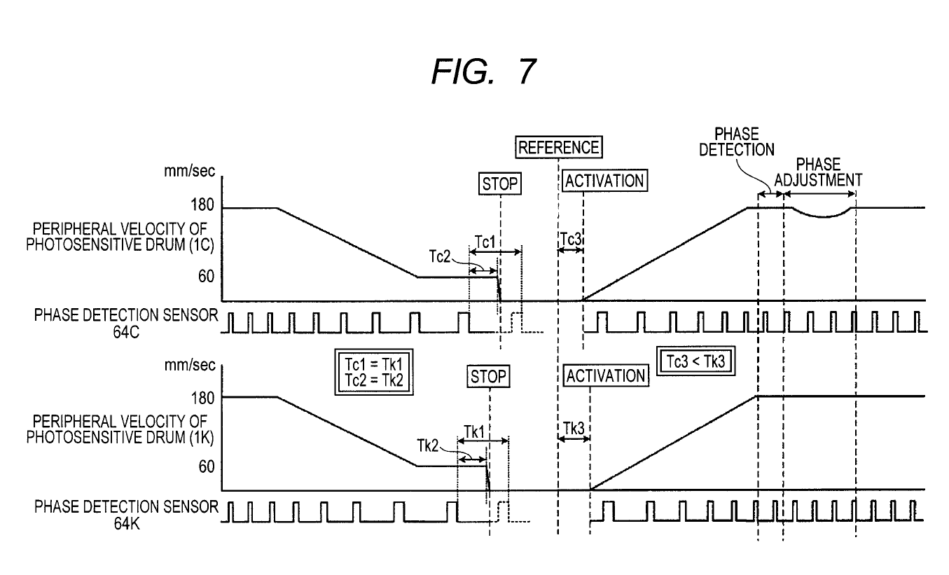

Next, the third embodiment of the present invention is described. The third embodiment is the same as the first embodiment in terms of the operation related to the phase detection and the phase adjustment, and relates to control of activation and stopping of the photosensitive drums 1C and 1K. In the same manner as in the first embodiment, the description of this embodiment is given assuming that the respective photosensitive drums 1Y, 1M, 1C, and 1K are driven by the two motors (for color and for black). Further, in the same manner as in the first embodiment, it is assumed that the rotation phases of the photosensitive drums 1Y, 1M, and 1C are the same all the time, and that the state in which the output timings of the signals from the phase detection sensors 64 for the respective photosensitive drums 1 match each other is the desired phase relationship that can suppress the color deviation of AC components. In this embodiment, stopping phases of the respective photosensitive drums 1C and 1K are the same and the activation timing is shifted at the next activation of the photosensitive drums 1C and 1K. FIG. 7 is referenced to describe an actual operation.

(Stopping and Activation of Photosensitive Drums)

FIG. 7 illustrates relationships between the peripheral velocities (mm/sec) of the photosensitive drums 1C and 1K and the output signals from the phase detection sensors 64C and 64K in cases of stopping and activating the photosensitive drums 1C and 1K, respectively. In FIG. 7, when the photosensitive drums 1C and 1K that are rotating at a peripheral velocity of 180 mm/sec are to be stopped, the rotation speed is temporarily reduced down to a peripheral velocity of 60 mm/sec. Note that, the phase relationship between the photosensitive drums 1C and 1K at this time is set to a predetermined positional relationship (phase relationship) in order to suppress the color deviation. When the peripheral velocities of the respective photosensitive drums 1C and 1K become 60 mm/sec (Tc1=Tk1), with falling signal flanks of the respective phase detection sensors 64C and 64K set as references, the photosensitive drums 1C and 1K are caused to stop at stop timings Tc2 and Tk2 (msec), respectively. With the stop timings satisfying a relationship of Tc2=Tk2, the phases of the respective photosensitive drums 1C and 1K are aligned when the photosensitive drums 1C and 1K are stopped. Then, at the next activation of the respective photosensitive drums 1C and 1K, the respective photosensitive drums 1C and 1K are activated at the activation timings Tc3 and Tk3 after the reference timing, respectively. The activation timings Tc3 and Tk3 satisfy a relationship of Tc3<Tk3, and the phase of the photosensitive drum 1C for color leads when the peripheral velocities of the respective photosensitive drums 1C and 1K reach the steady-state speed (180 (mm/sec)). That is, by which amount the value of Tc3 is larger than the value of Tk3 is determined depending on how much time the phase difference to be created between the respective photosensitive drums 1C and 1K corresponds to at the steady-state speed (180 (mm/sec)) at which the respective photosensitive drums 1C and 1K (or the corresponding motors 39) form images.

In the same manner as in the first embodiment, the phase detection and the phase adjustment are performed when the peripheral velocities of the photosensitive drums 1C and 1K reach the steady-state speed. In this embodiment, the phase of the photosensitive drum 1C leads (Ccnt<Kcnt), and hence it is basically unnecessary to perform the processing of S908 in FIG. 5. The phase lead amount can be set by the timings Tc3 and Tk3. For example, the timings Tc3 and Tk3 may be set to satisfy Tk3−Tc3=22 (msec) assuming that each photosensitive drum diameter is φ30 (mm), the peripheral velocity is 180 (mm/sec), and the phase lead amount of the photosensitive drum 1C is 15°. Note that, for the same reason as the second embodiment, the phase lead amount is set within the range from 0° to 180°. Then, if the flowchart of FIG. 5 is executed after performing the activation, the CPU 40 determines NO in S907 and performs the control to reduce the rotation speed of the motor 39C that is driving the photosensitive drum 1C to thereby perform the phase adjustment.

As described above, according to this embodiment, it is possible to realize one of preventing operation noise of the motor 39 from increasing in the phase adjustment of the photosensitive drum 1, reducing consumption power, or achieving a reduction in the motor specifications.

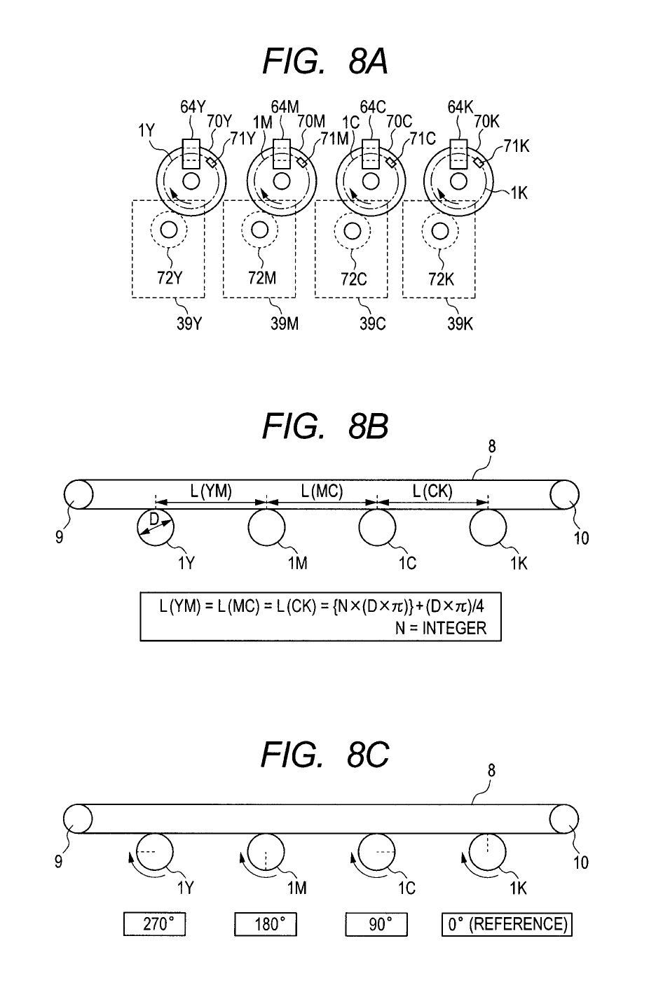

Next, the fourth embodiment is described. In this embodiment, as illustrated in FIG. 8A, the respective photosensitive drums 1Y, 1M, 1C, and 1K are driven by mutually different motors 39Y, 39M, 39C, and 39K, respectively. This assumes a structure in which phase detection sensors 64Y, 64M, 64C, and 64K and flags 71Y, 71M, 71C, and 71K are also provided to the respective photosensitive drums 1Y, 1M, 1C, and 1K, respectively. It is assumed that distances (L(YM), L(MC), and L(CK)) between the respective photosensitive drums according to this embodiment and a photosensitive drum diameter (D) have a relationship

(L(YM)=L(MC)=L(CK)={N×(D×π)}+(D+π)/4(N=integer))

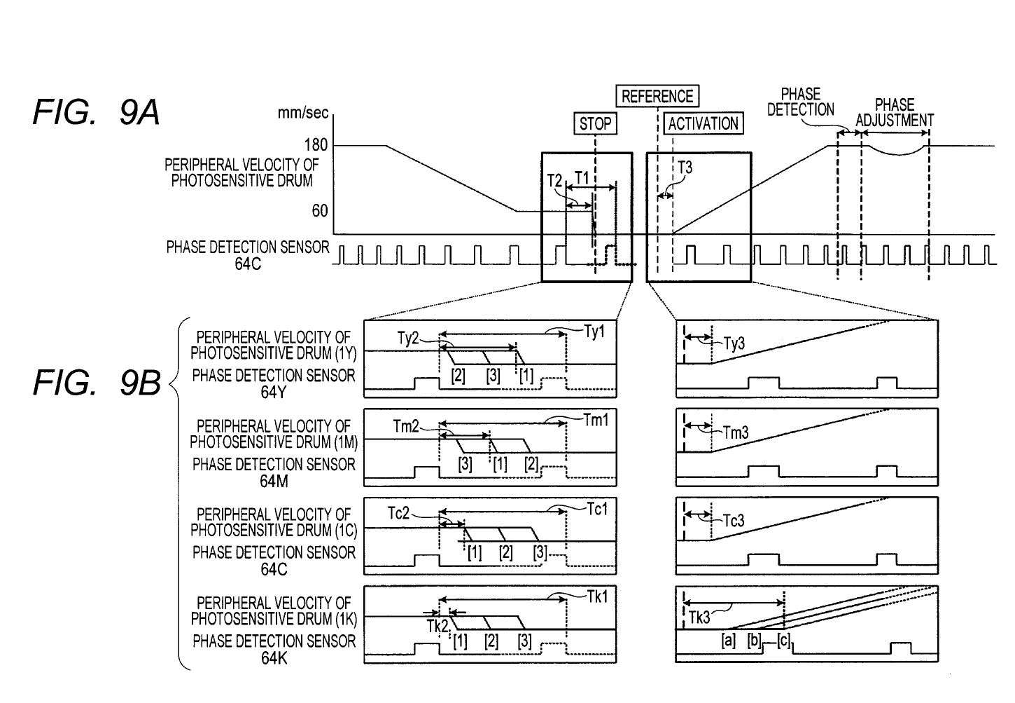

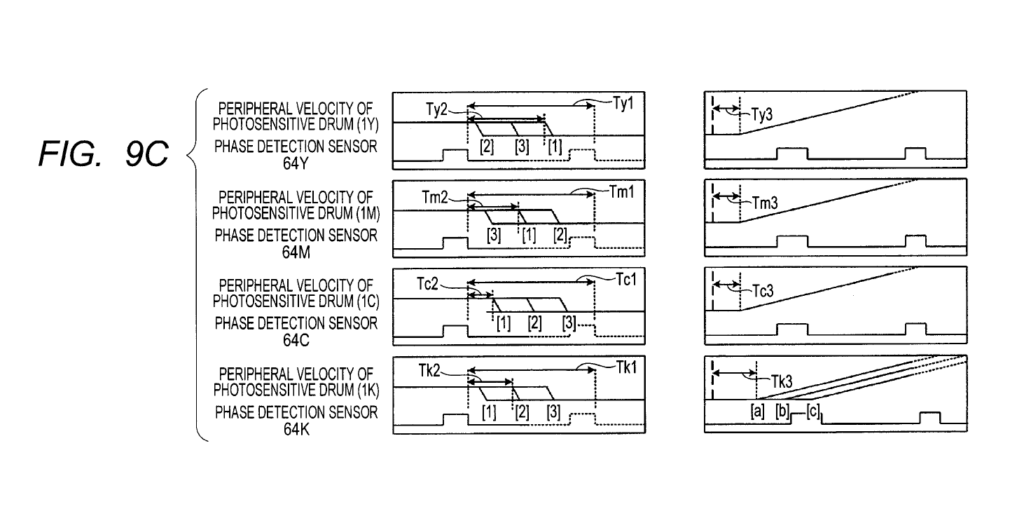

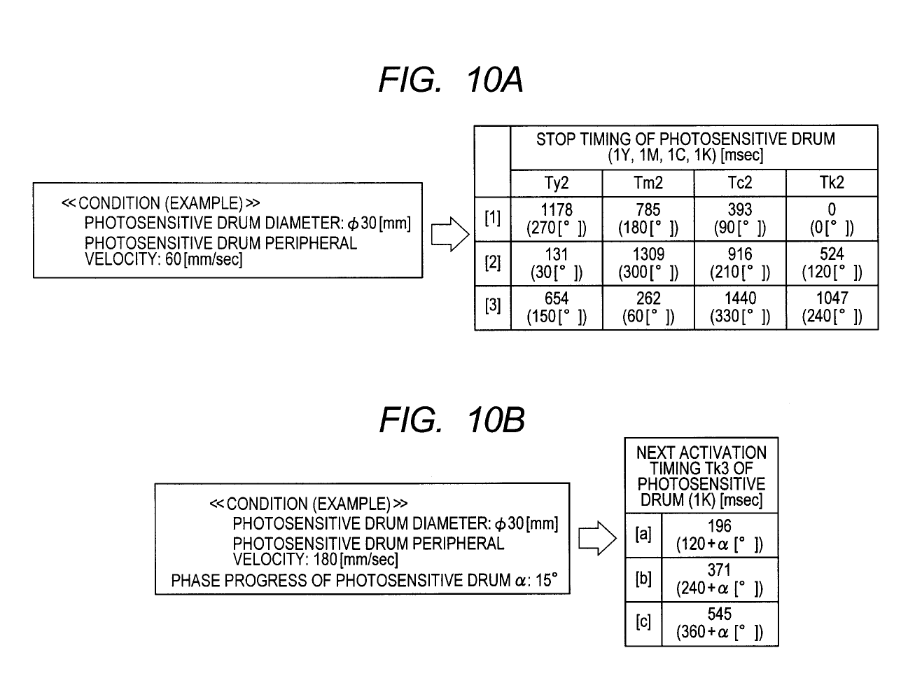

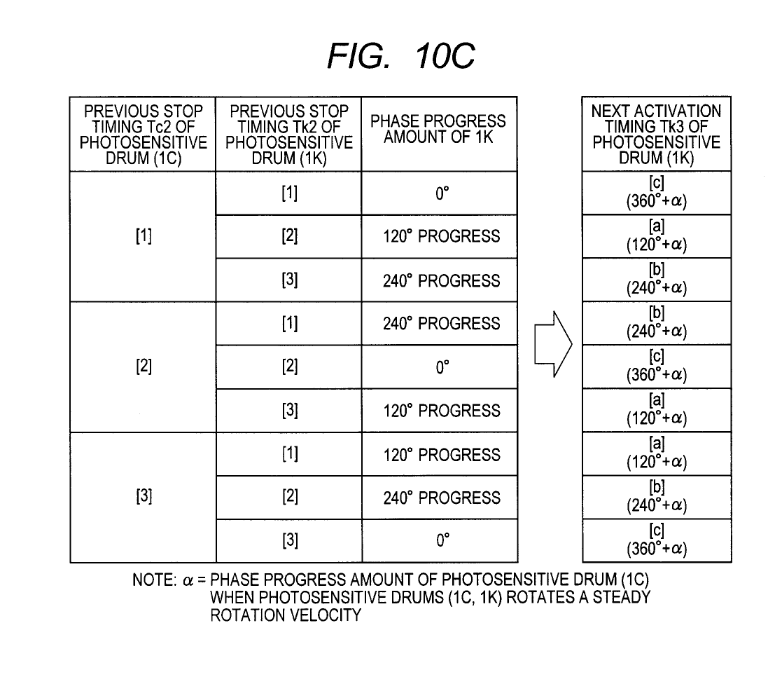

illustrated in FIG. 8B. With regard to the phases of the respective photosensitive drums 1, for example, the state in which the phase relationship illustrated in FIG. 8C is satisfied is the desired phase relationship that can suppress the color deviation of AC components. In this embodiment, the following processing is performed in addition to the processing according to the third embodiment (in which the stopping phases of the respective photosensitive drums 1 are the same and the activation timing is shifted at the next activation of the photosensitive drum 1). That is, in this embodiment, in order to prevent stop positions of the photosensitive drums 1 with respect to the intermediate transferring belt 8 from becoming the same at the stopping, three kinds of timings ([1] to [3] of FIGS. 9A, 9B, and 9C) are provided as stop timings Ty2, Tm2, Tc2, and Tk2 of the respective photosensitive drums 1Y, 1M, 1C, and 1K, respectively. Then, each time the photosensitive drum 1 is stopped, the stop timings Ty2, Tm2, Tc2, and Tk2 are switched over. Further, according to the switchover of the stop timings Ty2, Tm2, Tc2, and Tk2, the activation timing Tk3 of the photosensitive drum 1K with respect to the photosensitive drums 1Y, 1M, and 1C is also changed. FIGS. 9A, 9B, and 9C and FIG. 10 are referenced to describe the actual operation.

(Stop Timings and Activation Timings of Photosensitive Drums)

FIGS. 9A, 9B, and 9C illustrate relationships between the peripheral velocities (mm/sec) of the photosensitive drums 1Y, 1M, 1C, and 1K and the output signals from the phase detection sensors 64Y, 64M, 64C, and 64K in cases of stopping and activating the photosensitive drums 1Y, 1M, 1C, and 1K, respectively. In FIGS. 9A, 9B, and 9C, when the photosensitive drums 1Y, 1M, 1C, and 1K that are rotating at a peripheral velocity of 180 mm/sec are to be stopped, the rotation speed is temporarily reduced down to a peripheral velocity of 60 mm/sec. When the peripheral velocities of the respective photosensitive drums 1Y, 1M, 1C, and 1K become 60 mm/sec (Ty1=Tm1=Tc1=Tk1), the respective photosensitive drums 1Y, 1M, 1C, and 1K are caused to stop. In this case, with the falling signal flanks of the respective phase detection sensors 64Y, 64M, 64C, and 64K set as references, the photosensitive drums 1Y, 1M, 1C, and 1K are caused to stop at the stop timings Ty2, Tm2, Tc2, and Tk2 (msec), respectively. Here, the three kinds of timings ([1] to [3]) are provided to the stop timings Ty2, Tm2, Tc2, and Tk2. In this embodiment, Tk2 is set as 0°, 120°, and 240° in terms of the reference of the falling signal flank of the phase detection sensor 64K, and with the photosensitive drum 1K as the reference, the photosensitive drums 1Y, 1M, and 1C are stopped at the stop timings Ty2, Tm2, and Tc2 with the phases that can satisfy the relationship of FIG. 8C. For example, assuming that each photosensitive drum diameter is φ30 (mm) and the peripheral velocity is 60 (mm/sec), three kinds of timings [1] to [3] illustrated in FIG. 10A are obtained. The timings [1] to [3] of FIG. 10A correspond to the stop timings [1] to [3] illustrated in FIGS. 9A, 9B, and 9C.

The timings [1] to [3] are changed (incremented) in order of [1]→[2]→[3]→[1] each time the photosensitive drum 1 is stopped, and are set for the respective photosensitive drums 1Y, 1M, 1C, and 1K independently of one another. Here, the description is given by taking the relationship between the photosensitive drums 1C and 1K as an example. For example, when a full-color mode printing operation in which the photosensitive drums 1C and 1K are operated is finished, and when the respective photosensitive drums 1C and 1K are caused to stop at the timing [1], the stop timings used for the respective photosensitive drums 1C and 1K are incremented in preparation for the next stopping. However, when a monochrome mode printing operation in which only the photosensitive drum 1K is operated is finished, only the stop timing used for the photosensitive drum 1K is incremented. That is, the stop timings of the respective photosensitive drums 1C and 1K are independently changed according to the print mode, the phase relationship in the case where the respective photosensitive drums 1C and 1K is stopped is not always the same.

Therefore, in this embodiment, in consideration of the phase relationship in a state in which the respective photosensitive drums 1Y, 1M, 1C, and 1K are stopped, three kinds of timings (120°, 240°, and 360°) corresponding thereto are provided as the activation timing of the photosensitive drum 1K. For example, the timings illustrated in FIG. 10B are obtained assuming that each photosensitive drum diameter is φ30 (mm), the peripheral velocity is 180 (mm/sec), and the phase lead amount α of the photosensitive drum 1C is 15°. In other words, in order to set the phase lead amount α of the photosensitive drum 1C with respect to the photosensitive drum 1K, the photosensitive drum 1K is activated by adding the delay amount α to the activation timing of the photosensitive drum 10. Note that, the phase lead amount α is a lead amount of the rotation phase of the photosensitive drum 1C with respect to the photosensitive drum 1K obtained when the peripheral velocity of the photosensitive drum reaches the steady-state rotation after the photosensitive drum 1 is activated. The CPU 40 activates the photosensitive drum 1K with a delay of the time corresponding to the phase lead amount α. Here, in this embodiment, in order to avoid an overlap among activation currents for the respective motors 39Y, 39M, 39C, and 39K, the activation timing of the photosensitive drum 1K is prevented from being the same as the activation timings of the photosensitive drums 1Y, 1M, and 10. Specifically, for example, three different timings in terms of times corresponding to rotation phases of 120°, 240°, and 360° are provided as a timing to activate the photosensitive drum 1K with a delay with respect to the activation timing of the photosensitive drum 10. Further, as described above, selection of those activation timings [a] to [c] is automatically determined by the stop timings (phases) of the respective photosensitive drums 1Y, 1M, 1C, and 1K, and relationships thereof are obtained as illustrated in FIG. 10C.

Here, the “phase lead amount of 1K” of FIG. 10C is described. For example, the stop position of the photosensitive drum 1K is assumed as 0° in a case where the phase relationship between the photosensitive drum 1C and the photosensitive drum 1K is a positional relationship after the full-color mode printing operation is finished, in other words, a case where the photosensitive drums 1C and 1K are both stopped at the stop timing [1] as illustrated in FIG. 8C. If only the stop timing of the photosensitive drum 1K is incremented because, for example, the monochrome mode printing operation is finished with respect to the stop position of the photosensitive drum 1K, the stop position of the photosensitive drum 1K is 120° leading with respect to the position illustrated in FIG. 8C. Therefore, with reference to FIG. 10C, a consideration is given to a case where, for example, the stop timing Tc2 of the photosensitive drum 1C is [1] and the stop timing Tk2 of the photosensitive drum 1K is [2]. On such a condition, the phase of the photosensitive drum 1K in the case where the stop timing Tk2 is [2] is 120° leading with respect to a reference position (for example, 0°) of the photosensitive drum 1K after the full-color mode printing operation is finished.

FIG. 9B illustrates a case where the stopping is performed with the phase relationship of FIG. 8C after the full-color mode printing operation is finished or a case where the monochrome mode printing operation follows the finished full-color mode printing operation and only the photosensitive drum 1K is incremented to return to the relationship of FIG. 8C. In other words, FIG. 9B illustrates a case where the stop timings Tc2 and Tk2 of the photosensitive drums 1C and 1K are [1] and the next activation timing Tk3 of the photosensitive drum 1K is [c] with reference to FIG. 10C. In this case, the phase lead amount of the photosensitive drum 1K is 0°, and hence in order to set the same phase and avoid simultaneous activation, the CPU 40 activates the photosensitive drum 1K with a delay of a time obtained by adding the time corresponding to the phase lead amount α of the photosensitive drum 1C to the time corresponding to 360°. Meanwhile, FIG. 9C illustrates a case where the stopping is performed with the phase relationship of FIG. 8C after the full-color mode printing operation is finished, and then only the photosensitive drum 1K is incremented by the monochrome mode printing operation. In other words, FIG. 9C illustrates a case where the stop timing Tc2 of the photosensitive drum 1C is [1], the stop timing Tk2 of the photosensitive drum 1K is [2], and the next activation timing Tk3 of the photosensitive drum 1K is [a] with reference to FIG. 10C. In this case, the phase lead amount of the photosensitive drum 1K is 120°, and hence in order to set the rotation phase of the photosensitive drum 1K to the phase lead amount of 0° (the same phase) at the activation, the CPU 40 activates the photosensitive drum 1K with a delay of a time obtained by adding the time corresponding to the phase lead amount α of the photosensitive drum 10 to the time corresponding to leading 120°. The same applies to a case (not shown) where the photosensitive drum 10 is [1] and the photosensitive drum 1K is [3]. In other words, the phase lead amount of the photosensitive drum 1K is 240°, and hence in order to set the rotation phase of the photosensitive drum 1K to the phase lead amount of 0° (the same phase) at the activation, the CPU 40 activates the photosensitive drum 1K with a delay of a time obtained by adding the time corresponding to the phase lead amount α of the photosensitive drum 10 to the time corresponding to leading 240°.

(Processing Performed when Photosensitive Drums are Stopped)

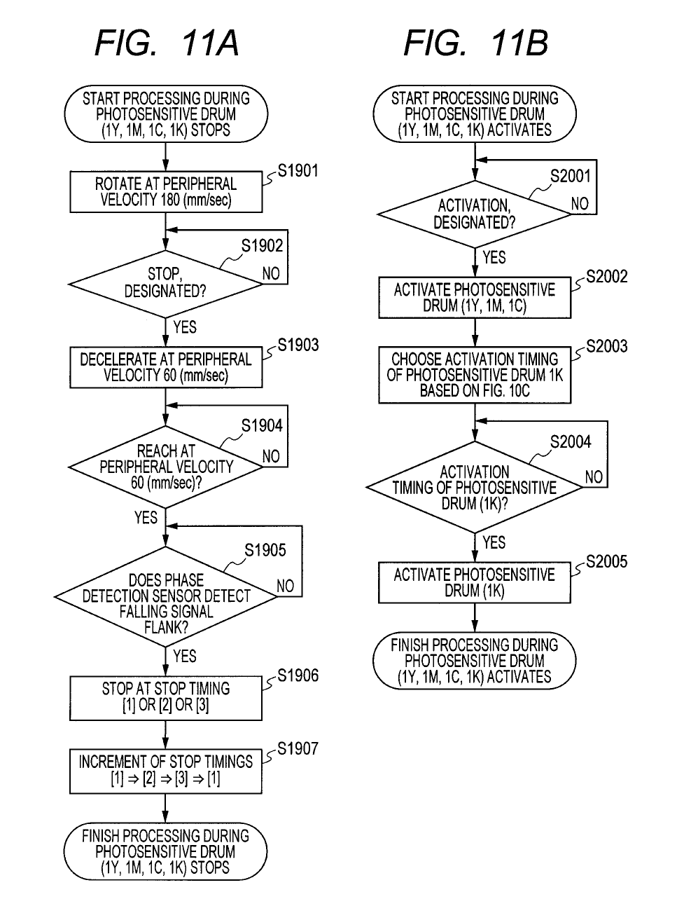

The flowchart of FIG. 11A is referenced to describe a flow of a stopping processing for the respective photosensitive drums 1Y, 1M, 10, and 1K according to this embodiment. Note that, the flowchart of FIG. 11A is executed in both a full-color mode and a monochrome mode. When the respective photosensitive drums 1Y, 1M, 10, and 1K are rotating at a peripheral velocity of 180 (mm/sec) in S1901, the CPU 40 determines whether or not a stop instruction has been received in S1902. If the CPU 40 determines that the stop instruction has been received in S1902, the peripheral velocities of the respective photosensitive drums 1Y, 1M, 1C, and 1K are reduced down to 60 (mm/sec) in S1903. When the CPU 40 determines that the peripheral velocities of the photosensitive drums 1Y, 1M, 1C, and 1K have reached 60 (mm/sec) in S1904, the CPU 40 detects the falling signal flanks of the phase detection sensors 64 in S1905. When the CPU 40 determines that the falling signal flanks of the phase detection sensors 64 have been detected in S1905, the CPU 40 causes the photosensitive drums 1Y, 1M, 1C, and 1K to stop at predetermined stop timings Tc2 and Tk2 ([1] or [2] or [3]) in S1906. At this time, the CPU 40 stores information indicating which of the stop timings was used for the stopping in, for example, the RAM 40b. Then, the CPU 40 increments the stop timings Tc2 and Tk2 (in an incremental order of [1]→[2]→[3]→[1]) in S1907, and brings the stopping processing to an end.

(Processing at Activation of Photosensitive Drums)

The flowchart of FIG. 11B is referenced to describe a flow of an activation processing for the respective photosensitive drums 1Y, 1M, 1C, and 1K according to this embodiment. If the printing instruction is received from the external computer 100, the CPU 40 determines that an activation instruction has been received in S2001, and activates the photosensitive drums 1Y, 1M, and 1C at activation timings Ty3, Tm3, and Tc3 after the reference timing in S2002. Then, in S2003, the CPU 40 selects the activation timing Tk3 ([a] or [b] or [c]) of the photosensitive drum 1K based on the information on the stop timing ([1] or [2] or [3]) stored in the RAM 40b in S1906 of FIG. 11A and the relationship illustrated in FIG. 10C. In S2003, the CPU 40 performs the following processing. That is, the activation timing is selected according to the phase relationship between the rotation phase in a case where the photosensitive drum 1K is stopped after image formation is performed in any one of the full-color mode and the monochrome mode and the rotation phase in a case where the photosensitive drum 1C is stopped after image formation is performed in the full-color mode. By the activation according to this selection, in the case where image formation is performed in the full-color mode, the rotation phase of the photosensitive drum 1C leads the rotation phase of the photosensitive drum 1K by a phase within a range from 0° to 180° when the motor 39C reaches the steady-state rotation speed used for image formation.

When the CPU 40 determines that the activation timing Tk3 of the photosensitive drum 1K has been reached in S2004, the CPU 40 activates the photosensitive drum 1K in S2005, and brings the activation processing to an end. By this processing, the phase of the photosensitive drum 1C leads (by the phase lead amount α of the photosensitive drum 1C) when the peripheral velocities of the respective photosensitive drums 1C and 1K reach the steady-state speed (180 (mm/sec)). In the same manner as in the first embodiment, the phase detection and the phase adjustment are performed when the peripheral velocities of the photosensitive drums 1C and 1K reach the steady-state speed. In this embodiment, the phase of the photosensitive drum 1C leads, and hence it is unnecessary to perform the processing of S908 of FIG. 5. Note that, for the same reason as in the second embodiment, the phase lead amount α is set within the range from 0° to 180°.

As described above, according to this embodiment, it is possible to realize any one of the following: preventing operation noise of the motor 39 from increasing in the phase adjustment of the photosensitive drum 1; reducing consumption power; and achieving a reduction in the motor specifications.

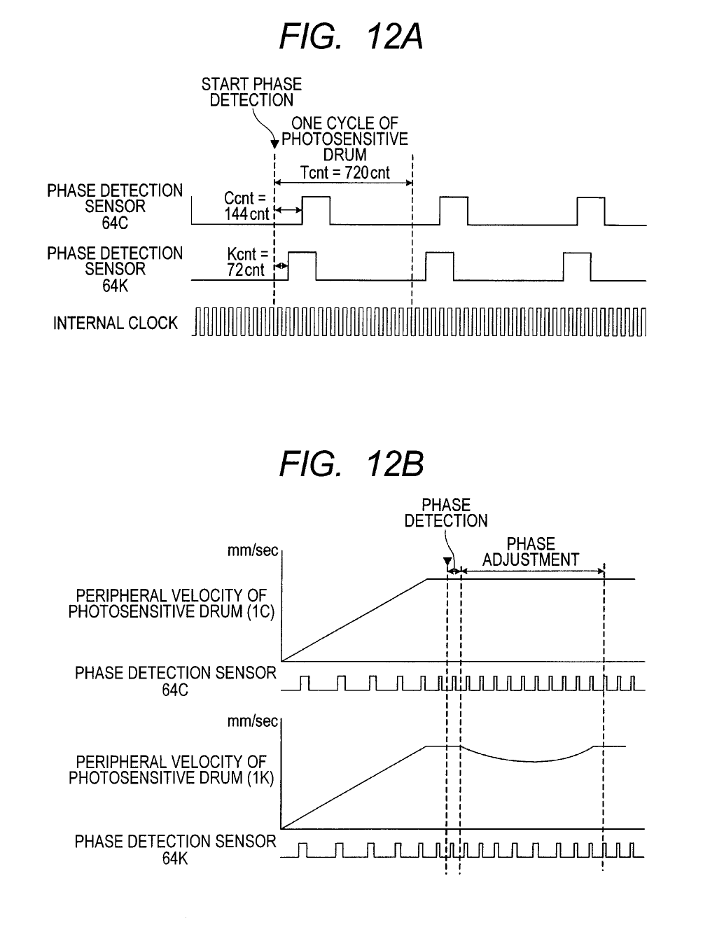

Next, a fifth embodiment of the present invention is described. The first to fourth embodiments are described based on the configuration in which the photosensitive drum 1K is set as the reference to adjust the phases of the other photosensitive drums. However, the present invention is not limited to the above-mentioned mode. The same effect as in the first embodiment can be produced by setting the photosensitive drum for another color as the reference. In this embodiment, without limiting the reference of the phase adjustment to the photosensitive drum 1K, the photosensitive drum whose phase was detected last after the start of the phase detection is set as the reference, and the phases are adjusted while reducing the other photosensitive drums. Note that, the description is given on the assumption that the image forming apparatus and the DC brushless motor have the same structures as those of the first embodiment, and that the respective photosensitive drums 1Y, 1M, 1C, and 1K are driven by the two motors (for color and for black). Further, in the same manner as in the first embodiment, it is assumed that the rotation phases of the photosensitive drums 1Y, 1M, and 1C for color are the same all the time, and that the state in which the output timings of the signals from the phase detection sensors 64C and 64K for the respective photosensitive drums 1 match each other is the desired phase relationship that can suppress the color deviation of AC components. FIGS. 12A and 12B are referenced to describe the actual operation according to this embodiment.

(Phase Lead Amount)

FIG. 12A is referenced to describe a rotation phase detection method for the photosensitive drums 1 according to this embodiment. Note that, description thereof that has already been given with reference to FIG. 4A is omitted to avoid a duplicate. The CPU 40 starts the count operations in synchronization with the internal clock at the timing to start the phase detection (indicated by the vertical broken line). Then, the CPU 40 stores the count value (Ccnt, Kcnt) obtained until the ascending flanks of the output signals from the phase detection sensors 64C and 64K are detected and an ascending-flank-detecting order of the photosensitive drums in, for example, the RAM 40b.

From the information on the ascending-flank-detecting order of the photosensitive drums stored in the RAM 40b, the CPU 40 determines the photosensitive drum whose phase was detected last after the start of the phase detection as a reference photosensitive drum. Subsequently, the CPU 40 calculates the lead amount of the photosensitive drum whose phase was detected first by performing calculation of Expression 1 assuming that the count value of the photosensitive drum whose phase was detected first is Cnt1 and that the count value of the photosensitive drum whose phase was detected last is Cnt2.

(Cnt2−Cnt1)/(Tcnt)×360 (deg) (Expression 1)

For example, in the case of FIG. 12A, the phases are detected in the order of the photosensitive drum 1K and the photosensitive drum 1C, Cnt1=Kcnt=72 cnt, Cnt2=Ccnt=144cnt, and Tcnt=720cnt.

The CPU 40 determines the photosensitive drum 1C whose phase was detected last as the reference photosensitive drum, substitutes the respective values into Expression 1, and determines that the phase of the photosensitive drum 1K leads the phase of the photosensitive drum 1C as the reference photosensitive drum by 36 deg (Expression 2).

(144cnt−72cnt)/(720cnt)×360 (deg)=36 (deg) (Expression 2)

(Phase Adjustment)

Next, FIG. 12B is referenced to describe a phase adjustment method for the photosensitive drums 1 according to this embodiment. FIG. 12B illustrates relationships between the peripheral velocities (mm/sec) of the photosensitive drums 1C and 1K and the output signals from the phase detection sensors 64C and 64K, respectively. Rotation phase detection and calculation of the phase shift amount described with reference to FIG. 12A are performed when the peripheral velocities of the photosensitive drums 1C and 1K reach the steady-state speed (steady-state rotation speed) after the photosensitive drums 1C and 1K are activated. The calculated phase lead amount (lead amount in FIG. 2C) is used for the position control performed by the CPU 40. The CPU 40 uses a result of the conversion for the speed control inside the CPU 40 as the position error information described above. As a result, the CPU 40 adjusts the rotation phases of the photosensitive drums 1C and 1K by outputting the drive signal (deceleration signal) to the motor 39K and reducing a rotation speed of the motor 39K. Note that, hereinafter, the wording “reducing the motor 39” means outputting the deceleration signal to the motor 39 based on an instruction issued from the CPU 40.

(Phase Adjustment Processing)

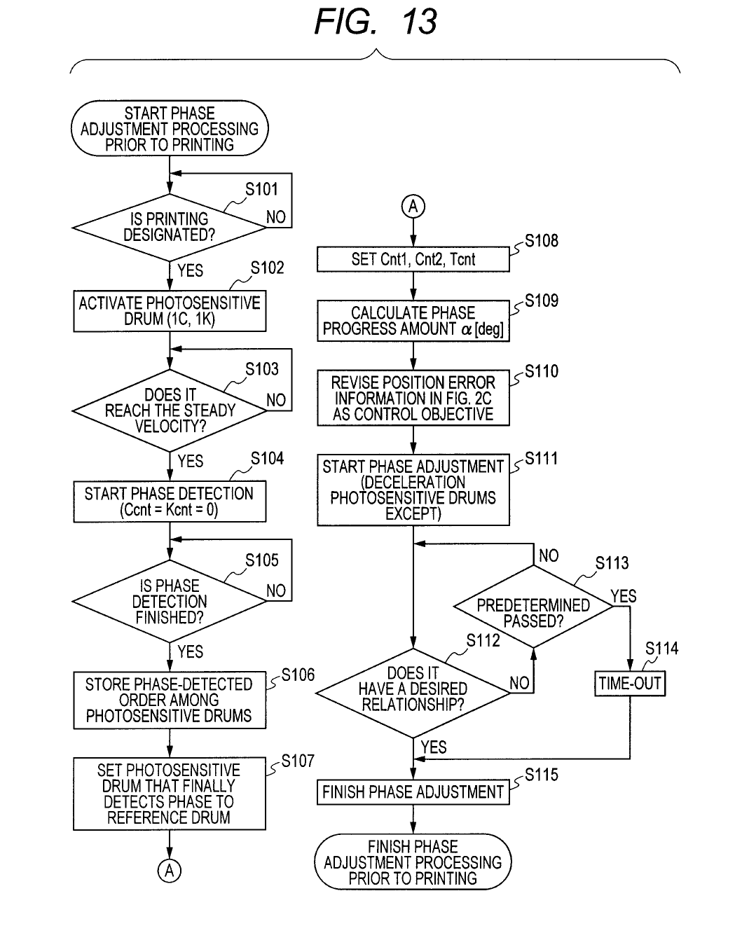

The flowchart of FIG. 13 is referenced to describe a flow of a phase adjustment processing prior to printing according to this embodiment. Note that, the processing of S101 to S103 is the same as the processing of S901 to S903 of FIG. 5 according to the first embodiment, and hence description thereof is omitted. In S104, the CPU starts the phase detection by the phase detection sensors 64C and 64K. In this case, the CPU 40 clears the count values Ccnt and Kcnt for the phase detection (Ccnt=Kcnt=0). Then, the CPU 40 executes the phase detection by the phase detection sensors 64C and 64K, and stores the count values Ccnt and Kcnt in the RAM 40b. Subsequently, when the CPU 40 determines that the phase detection has been finished in S105, the CPU 40 stores the phase-detecting order of the photosensitive drums in the RAM 40b in S106, and in S107, sets the photosensitive drum whose phase was detected last as the reference photosensitive drum for the phase adjustment. Subsequently, the CPU 40 sets the respective count values Cnt1, Cnt2, and Tcnt in S108, and in S109, calculates the phase lead amount α (deg) of another photosensitive drum with respect to the reference photosensitive drum according to (Expression 1). In S110, the CPU 40 revises the position error information by using the calculated the phase lead amount α for the position control of the photosensitive drum to be reduced as illustrated in FIG. 2C. In S111, the CPU 40 starts the phase adjustment based on the revised position error information. In other words, the CPU 40 starts the phase adjustment in order to cause the revised position error to become zero. In the phase adjustment, the CPU 40 reduces the rotation speed of the motor 39K that is driving another photosensitive drum (photosensitive drum 1K, in this embodiment) with respect to the reference photosensitive drum (photosensitive drum 1C, in this embodiment). After that, the processing of S112 to S115 performed by the CPU 40 are the same as the processing described with reference to S911 to S914 of FIG. 5, and hence description thereof is omitted.

As described above, according to this embodiment, even if the photosensitive drum for a specific color is not set as the reference photosensitive drum, it is possible to realize any one of the following: preventing operation noise of the motor 39 from increasing in the phase adjustment of the photosensitive drum 1; reducing consumption power; and achieving a reduction in the motor specifications.

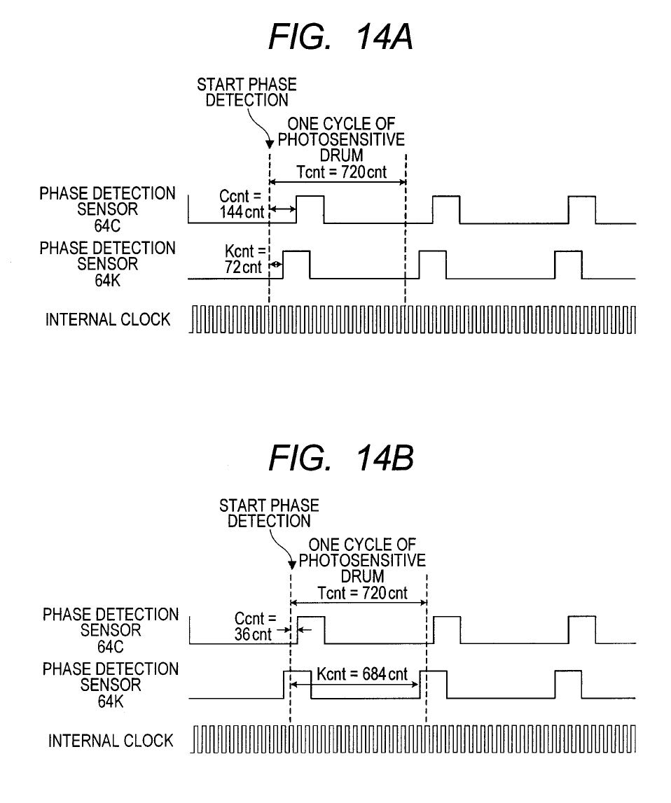

Next, a sixth embodiment of the present invention is described. In the fifth embodiment, a phase adjustment time may greatly increase depending on the timing to start the phase detection. For example, in the example of FIG. 12A, the phase adjustment time may greatly increase in a case where the phase detection is started immediately after the output signal rises from the phase detection sensor 64C or 64K. In this embodiment, the phase adjustment method for completing the phase adjustment in a short time irrespective of the timing to start the phase detection is described. Note that, the description is given on the assumption that the image forming apparatus and the DC brushless motor have the same structures as those of the first embodiment, and that the respective photosensitive drums 1Y, 1M, 1C, and 1K are driven by the two motors (for color and for black). Further, in the same manner as in the first embodiment, it is assumed that the rotation phases of the photosensitive drums 1Y, 1M, and 1C for color are the same all the time, and that the state in which the output timings of the signals from the phase detection sensors 64C and 64K for the respective photosensitive drums 1 match each other is the desired phase relationship that can suppress the color deviation of AC components. FIGS. 14A and 14B are referenced to describe the actual operation according to this embodiment.

(Decision of Reference Photosensitive Drum)

FIGS. 14A and 14B are diagrams illustrating cases where the phase detection is started at different timings with the same phase relationship. Note that, description thereof that has already been given with reference to FIG. 4A or FIG. 12A is omitted to avoid a duplicate.

The CPU 40 determines whether or not a relationship of Expression 3 is satisfied assuming that the count value of the photosensitive drum whose phase was detected first is Cnt1 and that the count value of the photosensitive drum whose phase was detected last is Cnt2.

Cnt2−Cnt1>(Cnt1+Tcnt)−Cnt2 (Expression 3)

The right-hand side of Expression 3 means a count value obtained when the ascending flank is detected one photosensitive drum cycle after the count value Cnt1 at which the ascending flank is detected. Expression 3 is assumed to be an expression for determining which of the phase difference between Cnt2 and Cnt1 and the phase difference between (Cnt1+Tcnt) and Cnt2 is larger/smaller.

If Expression 3 is satisfied, in other words, if the value of the left-hand side of Expression 3 (Cnt2−Cnt1) is larger, the photosensitive drum whose phase was detected first is determined as the reference photosensitive drum. On the other hand, if Expression 3 is not satisfied, in other words, if the value of the right-hand side of Expression 3 ((Cnt1+Tcnt)−Cnt2) is larger, the photosensitive drum whose phase was detected last is determined as the reference photosensitive drum.

For example, in the cases of FIGS. 14A and 14B, the count values Cnt1, Cnt2, and Tcnt and the phase-detecting order of the photosensitive drums are obtained as shown in Table 1.

TABLE 1

| | Cnt1 | | Cnt2 | | |
|---|---|---|---|---|---|
| | Count | Photosensitive | Count | Photosensitive | |
| | value | drum | value | drum | Tcnt |
| FIG. 14A | 72 | K | 144 | C | 720 |
| FIG. 14B | 36 | C | 684 | K | 720 |

Table 2 is obtained by calculating Expression 3 based on the results of Table 1, and the CPU 40 determines the photosensitive drum 1C as the reference photosensitive drum in any one of the cases of FIGS. 14A and 14B.

TABLE 2

| | Cnt2 − | (Cnt1 + Tcnt) − | |
|---|---|---|---|
| | Cnt1 | Cnt2 | Reference photosensitive drum |
| FIG. 14A | 72 | 648 | Photosensitive drum 1C whose |
| | | | phase was detected last |
| FIG. 14B | 648 | 72 | Photosensitive drum 1C whose |
| | | | phase was detected first |

(Phase Lead Amount)

Subsequently, the CPU 40 calculates the phase lead amount of the photosensitive drum other than the reference photosensitive drum according to formulae shown in Table 3 based on the determined reference photosensitive drum.

TABLE 3

| | | Formulae for phase lead |
|---|---|---|
| | Determined reference | amount of the other |
| | photosensitive drum | Photosensitive drum |
| FIG. 14A | Photosensitive drum | (Cnt2 − Cnt1)/Tcnt × 360 |
| | whose phase was | |
| | detected last | |
| FIG. 14B | Photosensitive drum | ((Cnt1 + Tcnt) − Cnt2)/Tcnt × 360 |
| | whose phase was | |
| | detected first | |

For example, in the cases of FIGS. 14A and 14B, the phase lead amount of the photosensitive drum 1K with respect to the photosensitive drum 1C as the reference photosensitive drum is obtained as shown in Table 4, and it is determined that the photosensitive drum 1K is 36 (deg) leading in both the cases. The CPU 40 performs the phase adjustment by reducing the photosensitive drum other than the reference photosensitive drum based on the calculated phase lead amount. Note that, the “Phase adjustment” after the calculation of the phase lead amount is the same as that of the fifth embodiment, and hence description thereof is omitted.

TABLE 4

| | Phase lead amount |
|---|---|
| | [deg] |
| FIG. 14A | 36 |
| FIG. 14B | 36 |

(Phase Adjustment Processing)

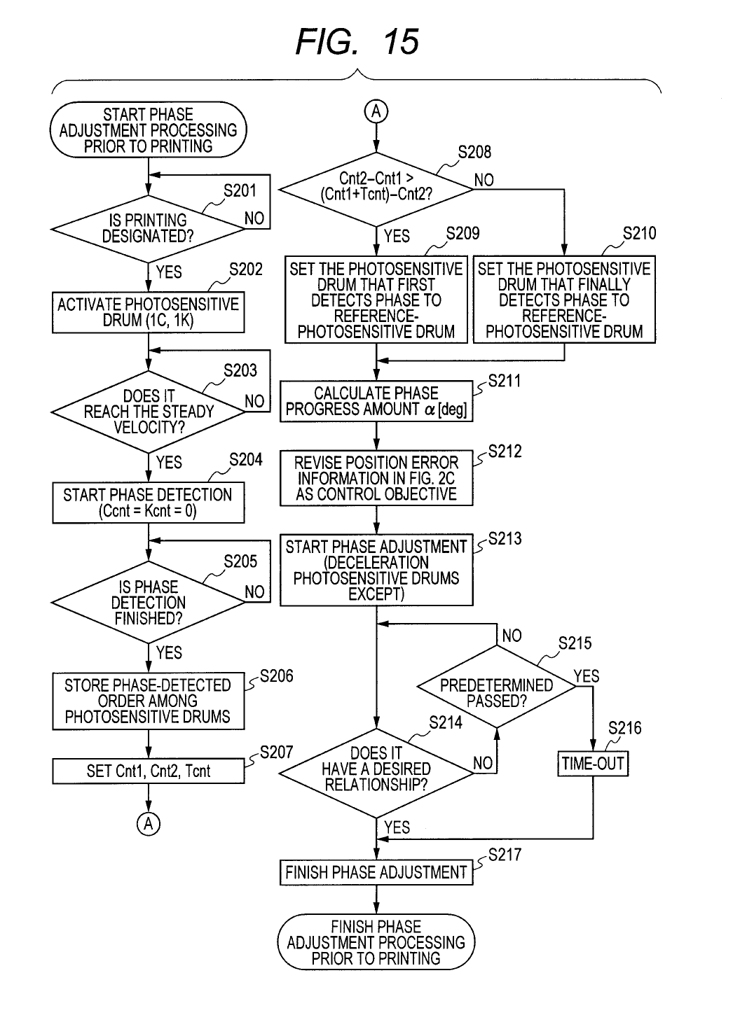

The flowchart of FIG. 15 is referenced to describe a flow of a phase adjustment processing prior to printing according to this embodiment. Note that, the processing of S201 to S203 is the same as the processing of S901 to S903 of FIG. 5 according to the first embodiment, and hence description thereof is omitted. In S204, the CPU starts the phase detection by the phase detection sensors 64C and 64K. In this case, the CPU 40 clears the count values Ccnt and Kcnt for the phase detection (Ccnt=Kcnt=0). Then, the CPU 40 executes the phase detection by the phase detection sensors 64C and 64K, and stores the count values Ccnt and Kcnt in the RAM 40b. Subsequently, when the CPU 40 determines that the phase detection has been finished in S205, the CPU 40 stores the phase-detecting order of the photosensitive drums in the RAM 40b in S206, and in S207, sets the respective count values Cnt1, Cnt2, and Tcnt. Subsequently, in S208, the CPU 40 determines whether or not Expression 3 is satisfied. If the CPU 40 determines that Expression 3 is satisfied in S208, the CPU 40 determines in S209 the photosensitive drum whose phase was detected first as the reference photosensitive drum from the information on the order stored in the RAM 40b in S206.

Further, if the CPU 40 determines that Expression 3 is not satisfied in S208, the CPU 40 determines in S210 the photosensitive drum whose phase was detected last as the reference photosensitive drum from the information on the order stored in the RAM 40b in S206. After that, in S211, the phase lead amount α (deg) of the other photosensitive drum is calculated according to the formulae shown in Table 3. In S212, the CPU 40 revises the position error information by using the calculated the phase lead amount α for the position control of the photosensitive drum to be reduced as illustrated in FIG. 2C. In S213, the CPU 40 starts the phase adjustment based on the revised position error information. In other words, the CPU 40 starts the phase adjustment in order to cause the revised position error to become zero. In the phase adjustment, the CPU 40 reduces the rotation speed of the motor 39K that is driving another photosensitive drum (photosensitive drum 1K, in this embodiment) with respect to the reference photosensitive drum (photosensitive drum 1C, in this embodiment). After that, the processing of S214 to S217 performed by the CPU 40 are the same as the processing described with reference to S911 to S914 of FIG. 5, and hence description thereof is omitted.

As described above, according to this embodiment, it is possible to realize any one of the following: preventing operation noise of the motor 39 from increasing in the phase adjustment of the photosensitive drum 1; reducing consumption power; and achieving a reduction in the motor specifications. In addition, the phase adjustment time can be further reduced compared with the cases of the first and fifth embodiments.

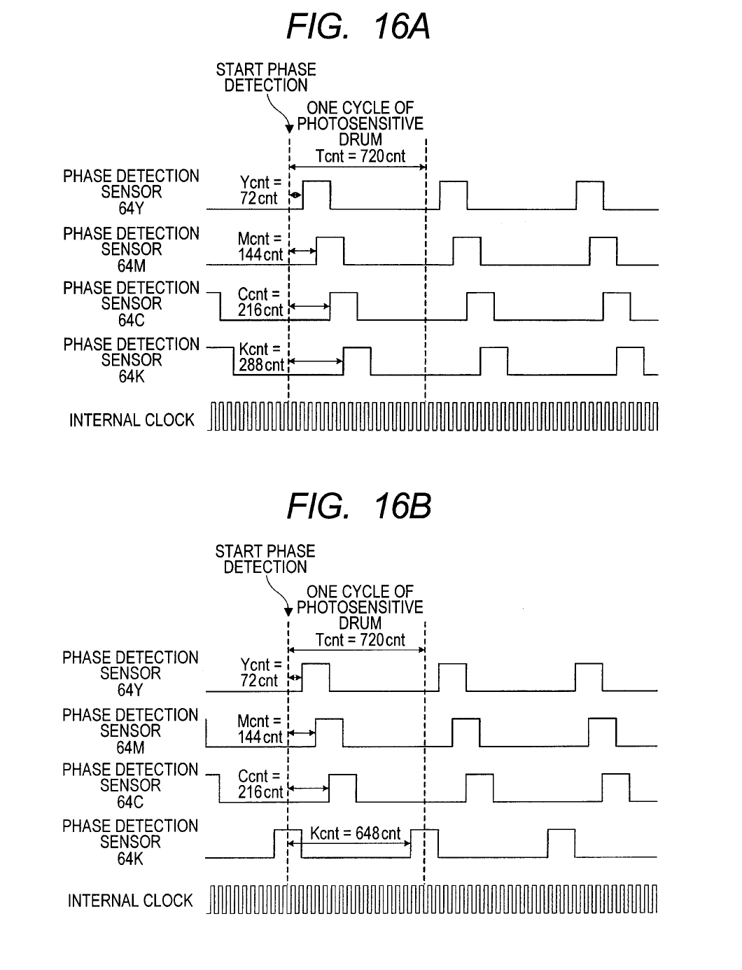

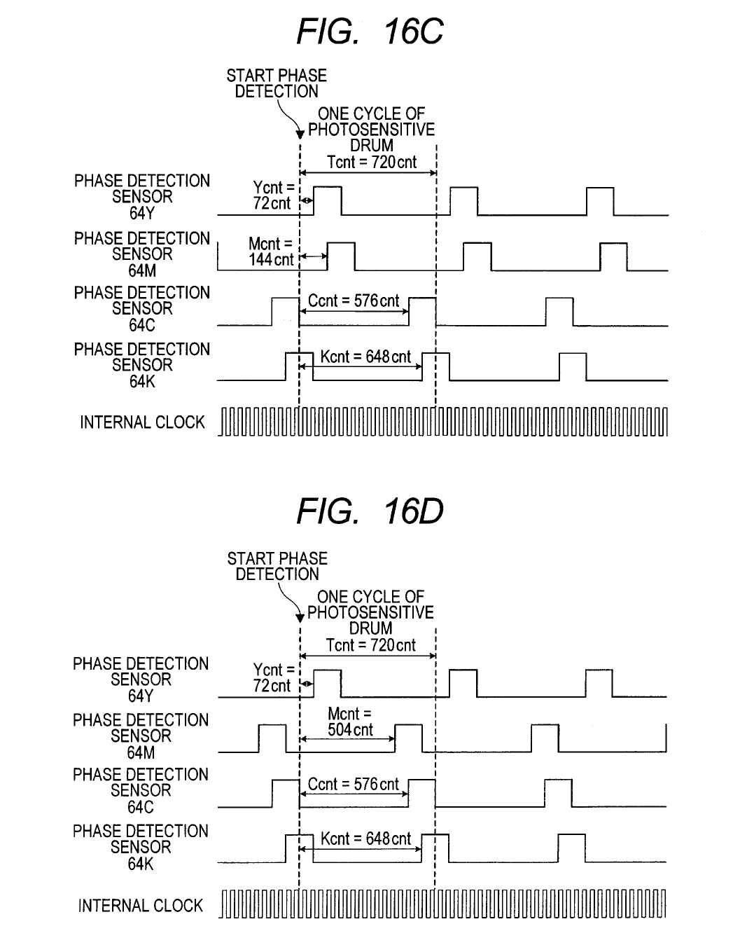

Next, a seventh embodiment of the present invention is described. The sixth embodiment is described based on the configuration in which the respective photosensitive drums 1Y, 1M, 1C, and 1K are driven by the two motors (for color and for black). This embodiment is described by using a configuration in which the respective photosensitive drums 1Y, 1M, 1C, and 1K are driven by motors independent of one another. Note that, the image forming apparatus and the DC brushless motor have the same structures as those of the fourth embodiment, and hence description thereof is omitted. Further, the state in which the output timings of the signals from the phase detection sensors 64Y, 64M, 64C, and 64K of the respective photosensitive drums 1 match one another is assumed to be the desired phase relationship that can suppress the color deviation of AC components. FIGS. 16A, 16B, 16C, and 16D are referenced to describe actual operations according to this embodiment.

(Decision of Reference Photosensitive Drum)

FIGS. 16A, 16B, 16C, and 16D each illustrate the waveforms of the output signals from the phase detection sensors 64Y, 64M, 64C, and 64K for detecting the rotation phases of the photosensitive drums 1 and a waveform of the internal clock generated inside the CPU 40. FIGS. 16A, 16B, 16C, and 16D illustrate examples using the reference photosensitive drum different from one another.

The CPU 40 starts the phase detection at the arbitrary timing after the peripheral velocity of the photosensitive drum 1 reaches the steady-state speed. The CPU 40 starts the count operations in synchronization with the internal clock at the timing to start the phase detection (indicated by the vertical broken line). Then, the CPU 40 stores the count values (Ycnt, Mcnt, Ccnt, and Kcnt) obtained until the ascending flanks of the output signals from the phase detection sensors 64Y, 64M, 64C, and 64K are detected and the ascending-flank-detecting order of the photosensitive drums in, for example, the RAM 40b. Further, the CPU 40 prestores the count value (Tcnt: photosensitive drum cycle) obtained when the photosensitive drum 1 rotates one turn in, for example, the RAM 40b. Note that, the count value (Tcnt: photosensitive drum cycle) obtained when the photosensitive drum 1 rotates one turn may be measured as necessary or may be prestored.

Subsequently, the CPU 40 sets the count value of the photosensitive drum whose phase was detected first to Cnt1 and the count value of the photosensitive drum whose phase was detected second to Cnt2. In addition, the CPU 40 sets the count value of the photosensitive drum whose phase was detected third to Cnt3 and the count value of the photosensitive drum whose phase was detected fourth to Cnt4, and performs calculations of Expression 4 to Expression 7. According to Expression 4 to Expression 7, the CPU 40 determines which of the photosensitive drums is to be regarded as being the most delayed in a relative relationship among the phases of the four photosensitive drums in order to obtain the smallest amounts of the phases to be adjusted by reducing rotation speeds of motors for driving the other image bearing members.

Cnt4−Cnt1 (Expression 4)

Cnt3−(Cnt4−Tcnt) (Expression 5)

Cnt2−(Cnt3−Tcnt) (Expression 6)

Cnt1−(Cnt2−Tcnt) (Expression 7)

In other words, Expression 4 is used to calculate by how much the phase of the photosensitive drum whose phase was detected fourth is delayed relatively behind the phase of the photosensitive drum whose phase was detected first. Expression 5 is used to return the phase of the photosensitive drum whose phase was detected fourth by one cycle in order to regard the phase of, the photosensitive drum whose phase was detected third as being the most delayed. In the same manner as in Expression 5, in Expression 6 and Expression 7, the phase of the photosensitive drum whose phase was detected second and the phase of the photosensitive drum whose phase was detected first, respectively, are regarded as being the most delayed. Then, if the value of Expression 4 is the smallest, the photosensitive drum whose phase was detected fourth is determined as the reference photosensitive drum, and if the value of Expression 5 is the smallest, the photosensitive drum whose phase was detected third is determined as the reference photosensitive drum. Further, if the value of Expression 6 is the smallest, the photosensitive drum whose phase was detected second is determined as the reference photosensitive drum, and if the value of Expression 7 is the smallest, the photosensitive drum whose phase was detected first is determined as the reference photosensitive drum.

For example, in the cases of FIGS. 16A, 16B, 16C, and 16D, the count values Cnt1, Cnt2, Cnt3, Cnt4, and Tcnt and the phase-detecting order of the photosensitive drums are obtained as shown in Table 5, and calculation results from Expression 4 to Expression 7 and the reference photosensitive drums determined from the calculation results are obtained as shown in Table 6.

TABLE 5

| | Cnt1 | | Cnt2 | | Cnt3 | | Cnt4 | | |
|---|---|---|---|---|---|---|---|---|---|
| | Count | Photosensitive | Count | Photosensitive | Count | Photosensitive | Count | Photosensitive | |
| | value | drum | value | drum | value | drum | value | drum | Tcnt |
| FIG. 16A | 72 | Y | 144 | M | 216 | C | 288 | K | 720 |
| FIG. 16B | 72 | Y | 144 | M | 216 | C | 648 | K | 720 |
| FIG. 16C | 72 | Y | 144 | M | 576 | C | 648 | K | 720 |
| FIG. 16D | 72 | Y | 504 | M | 576 | C | 648 | K | 720 |

TABLE 6

| | | Expression 5 | Expression 6 | Expression 7 | |
|---|---|---|---|---|---|
| | Expression 4 | Cnt3 − | Cnt2 − | Cnt1 − | Determined reference |
| | Cnt4 − Cnt1 | (Cnt4 − Tcnt) | (Cnt3 − Tcnt) | (Cnt2 − Tcnt) | photosensitive drum |
| FIG. 16A | 216 | 648 | 648 | 648 | Photosensitive drum 1K whose |
| | | | | | phase was detected fourth |
| FIG. 16B | 576 | 288 | 648 | 648 | Photosensitive drum 1C whose |
| | | | | | phase was detected third |
| FIG. 16C | 576 | 648 | 288 | 648 | Photosensitive drum 1M whose |
| | | | | | phase was detected second |
| FIG. 16D | 576 | 648 | 648 | 288 | Photosensitive drum 1Y whose |
| | | | | | phase was detected first |

Here, the smallest value among the values of Expression 4 to Expression 7 calculated to determine the reference photosensitive drum (hereinafter, referred to as “minimum value of the relative phase shift amount”) falls within a range from 0° to 270°. The minimum value of the relative phase shift amount becomes 270° when the relative phase shift amounts of the photosensitive drum whose phase was detected first to the photosensitive drum whose phase was detected fourth within the photosensitive drum cycle (for example, 720 cnt) respectively become 90° (180 cnt in terms of the count value). In this case, all the values calculated by Expression 4 to Expression 7 become 540 cnt (270°). For example, in the case of FIG. 16B, with the timing to start the phase detection set as the reference, the photosensitive drum 1K is the photosensitive drum whose phase is the most delayed. However, when Expression 4 to Expression 7 according to this embodiment are used, the value of Expression 4 is calculated first because the photosensitive drum 1K was detected fourth (Kcnt=Cnt4), and the Expression 4 produces a value of 576 cnt. In other words, this value becomes 288° larger than 270°, and in this embodiment, the photosensitive drum 1K is not set as the reference photosensitive drum. In the case of FIG. 16B, the calculation results of Expression 6 and Expression 7 are also larger than 270°, and the photosensitive drum 1C corresponding to the photosensitive drum whose phase was detected third obtained from Expression 5 as shown in Table 6 is set as the reference photosensitive drum.

(Phase Lead Amount)

Subsequently, the CPU 40 calculates the phase lead amounts of the photosensitive drums other than the reference photosensitive drum according to formulae of any one of [1] to [4] shown in Table 7 based on the determined reference photosensitive drum. For example, in a case where the reference photosensitive drum is the photosensitive drum whose phase was detected fourth, based on Table 7-[1], the phase lead amount of the photosensitive drum whose phase was detected first is calculated by performing the calculation of (Cnt4−Cnt1)/Tcnt×360. Further, based on Table 7-[1], the phase lead amount of the photosensitive drum whose phase was detected second is calculated by performing the calculation of (Cnt4−Cnt2)/Tcnt×360, and the phase lead amount of the photosensitive drum whose phase was detected third is calculated by performing the calculation of (Cnt4−Cnt3)/Tcnt×360.

TABLE 7

| | | Formulae for phase lead amounts of | | | |
|---|---|---|---|---|---|
| | | respective photosensitive drums | | | |
| | | Photosensitive | Photosensitive | Photosensitive | Photosensitive |
| | | drum whose phase | drum whose phase | drum whose phase | drum whose phase |
| | Reference | was detected | was detected | was detected | was detected |
| | photosensitive drum | first | second | third | fourth |
| [1] | Photosensitive drum | (Cnt4 − Cnt1)/ | (Cnt4 − Cnt2)/ | (Cnt4 − Cnt3)/ | 0 |
| | whose phase was | Tcnt × 360 | Tcnt × 360 | Tcnt × 360 | |
| | detected fourth | | | | |
| [2] | Photosensitive drum | (Cnt3 − Cnt1)/ | (Cnt3 − Cnt2)/ | 0 | (Cnt3 − (Cnt4 − |
| | whose phase was | Tcnt × 360 | Tcnt × 360 | | Tcnt))/ |
| | detected third | | | | Tcnt × 360 |
| [3] | Photosensitive drum | (Cnt2 − Cnt1)/ | 0 | (Cnt2 − (Cnt3 − | (Cnt2 − (Cnt4 − |
| | whose phase was | Tcnt × 360 | | Tcnt))/ | Tcnt))/ |
| | detected second | | | Tcnt × 360 | Tcnt × 360 |
| [4] | Photosensitive drum | 0 | (Cnt1 − (Cnt2 − | (Cnt1 − (Cnt3 − | (Cnt1 − (Cnt4 − |
| | whose phase was | | Tcnt))/ | Tcnt))/ | Tcnt))/ |
| | detected first | | Tcnt × 360 | Tcnt × 360 | Tcnt × 360 |

In the cases of FIGS. 16A, 16B, 16C, and 16D, the phase lead amounts of the photosensitive drums with respect to the determined reference photosensitive drum are obtained as shown in Table 8. The CPU 40 performs the phase adjustment by reducing the photosensitive drums other than the reference photosensitive drum based on the calculated phase lead amounts. Note that, the “Phase adjustment” after the calculation of the phase lead amounts is the same as that of the fifth embodiment, and hence description thereof is omitted.

TABLE 8

| | |
|---|---|
| Reference | Phase lead amounts of respective |
| photosensitive | photosensitive drums [deg] |

| | drum | Y | M | C | K |
|---|---|---|---|---|---|
| FIG. 16A | K | 108 | 72 | 36 | 0 |
| FIG. 16B | C | 72 | 36 | 0 | 144 |
| FIG. 16C | M | 36 | 0 | 144 | 108 |
| FIG. 16D | Y | 0 | 144 | 108 | 72 |

(Phase Adjustment Processing)

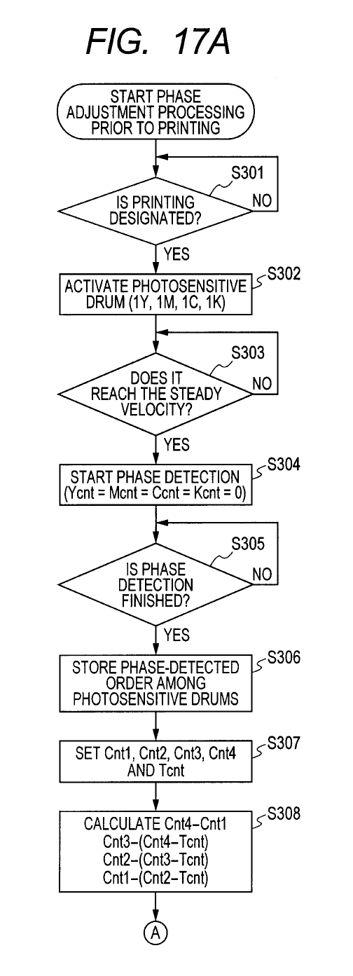

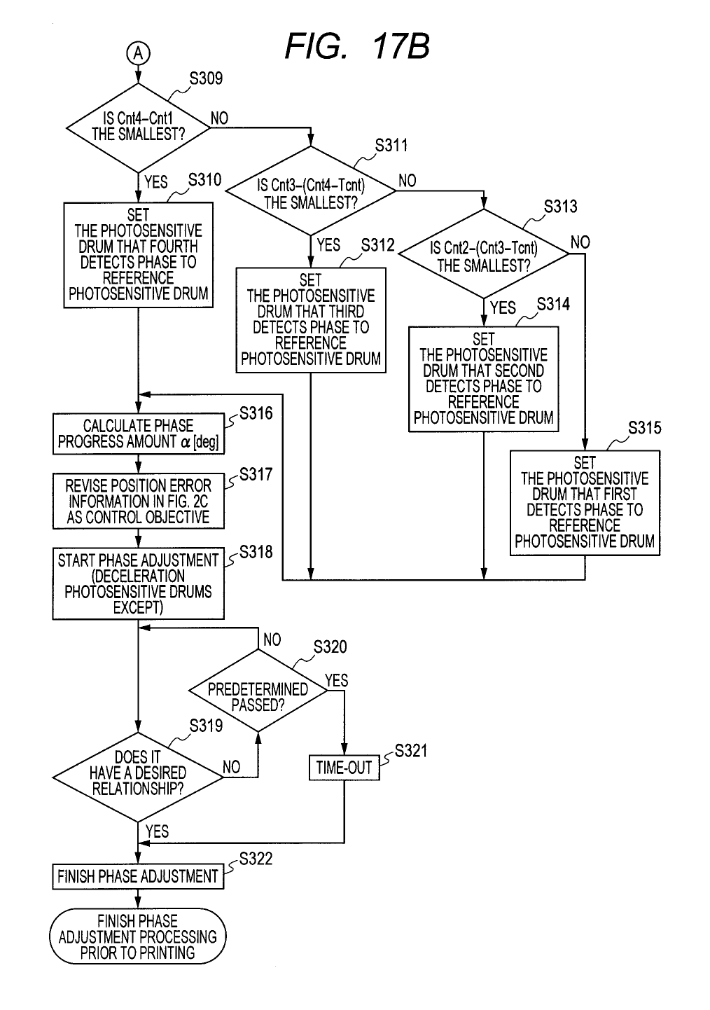

The flowchart of FIGS. 17A and 17B is referenced to describe a flow of a phase adjustment processing prior to printing according to this embodiment. When the CPU 40 determines that there is a printing instruction received from the external computer 100 or the like in S301, the CPU 40 starts (activates) driving of the photosensitive drums 1Y, 1M, 1C, and 1K by the motors 39Y, 39M, 39C, and 39K in S302. Note that, here, the printing instruction is accompanied by the image data supplied from the external computer 100. When the CPU 40 determines that the peripheral velocities of the photosensitive drums 1Y, 1M, 1C, and 1K have reached the steady-state speed in S303, the CPU 40 starts the phase detection by the phase detection sensors 64Y, 64M, 64C, and 64K in S304. In this case, the CPU 40 clears the count values Ycnt, Mcnt, Ccnt, and Kcnt for the phase detection (Ycnt=Mcnt=Ccnt=Kcnt=0). Then, the CPU 40 executes the phase detection by the phase detection sensors 64Y, 64M, 64C, and 64K, and stores the count values Ycnt, Mcnt, Ccnt, and Kcnt in, for example, the RAM 40b. Subsequently, when the CPU 40 determines that the phase detection has been finished in S305, the CPU 40 stores the phase-detecting order of the photosensitive drums in, for example, the RAM 40b in S306, and in S307, the CPU 40 sets count values Cnt1, Cnt2, Cnt3, Cnt4, and Tcnt.

Subsequently, in S308, the CPU 40 calculates the values of Expression 4 to Expression 7 from the set count values Cnt1, Cnt2, Cnt3, Cnt4, and Tcnt. The calculation results are obtained as shown in Table 6. In S309, the CPU 40 determines whether or not the value of Expression 4 is the smallest among the calculated values of Expression 4 to Expression 7. If the CPU 40 determines that the value of Expression 4 is the smallest in S309, the CPU 40 sets the photosensitive drum whose phase was detected fourth as the reference photosensitive drum in S310. If the CPU 40 determines that the value of Expression 4 is not the smallest in S309, the CPU 40 determines whether or not the value of Expression 5 is the smallest in S311. If the CPU 40 determines that the value of Expression 5 is the smallest in S311, the CPU 40 sets the photosensitive drum whose phase was detected third as the reference photosensitive drum in S312. If the CPU 40 determines that the value of Expression 5 is not the smallest in S311, the CPU 40 determines whether or not the value of Expression 6 is the smallest in S313. If the CPU 40 determines that the value of Expression 6 is the smallest in S313, the CPU 40 sets the photosensitive drum whose phase was detected second as the reference photosensitive drum in S314. If the CPU 40 determines that the value of Expression 6 is not the smallest in S313, in other words, if the value of Expression 7 is the smallest, the CPU 40 sets the photosensitive drum whose phase was detected first as the reference photosensitive drum in S315. As described above, the CPU 40 determines the reference photosensitive drum by the expression producing the smallest value after calculating Expression 4 to Expression 7 in S308 to S315. It is possible to determine which of the photosensitive drums is to be regarded as being the most delayed in the relative relationship among the phases of the four photosensitive drums in order to obtain the smallest phase adjustment amount.

After that, in S316, the CPU 40 calculates the phase lead amounts a (deg) of the other photosensitive drums according to the expressions shown in Table 7. In S317, the CPU 40 revises the position error information by using the calculated phase lead amount α for the position control of the photosensitive drum to be reduced as illustrated in FIG. 2C. In S318, the CPU 40 starts the phase adjustment based on the revised position error information. In other words, the CPU 40 starts the phase adjustment in order to cause the revised position error to become zero. In the phase adjustment, the CPU 40 reduces the rotation speed of the motor 39 that is driving another photosensitive drum with respect to the reference photosensitive drum. After that, the processing of S319 to S322 performed by the CPU 40 are the same as the processing described with reference to S911 to S914 of FIG. 5, and hence description thereof is omitted.

As described above, according to this embodiment, it is possible to obtain at least the same effects as in the above-mentioned embodiments. In addition to those effects, according to this embodiment, in the structure in which the respective photosensitive drums 1Y, 1M, 1C, and 1K are driven by motors independent of one another, it is possible to determine the photosensitive drum as the reference so as to reduce the time required for the phase adjustment to a minimum level.

Note that, in this embodiment, the photosensitive drum having the smallest phase adjustment amount is determined as the photosensitive drum of the reference. However, any one of the photosensitive drums may be determined as the photosensitive drum of the reference unless the photosensitive drum has the largest phase adjustment amount. For example, as a result of calculating Expression 4 to Expression 7, the CPU 40 may be caused to perform calculation to determine the photosensitive drum exhibiting the second or third smallest value as the photosensitive drum as the reference. With this configuration, compared with the case where the photosensitive drum exhibiting the fourth smallest value is set as the reference, it is more likely to produce at least an effect that operation noise of a drive part can be prevented from increasing in performing the phase adjustment of the image bearing member, consumption power can be reduced, or a reduction in motor specifications can be performed.

Next, an eighth embodiment of the present invention is described. This embodiment is the same as the first or fifth embodiment in terms of the operation related to the phase detection and the phase adjustment, and relates to the control of the activation and the stopping of the photosensitive drums 1C and 1K. In the same manner as in the first embodiment, the description of this embodiment is given assuming that the respective photosensitive drums 1Y, 1M, 1C, and 1K are driven by the two motors (for color and for black). Further, in the same manner as in the first embodiment, it is assumed that the rotation phases of the photosensitive drums 1Y, 1M, and 1C are the same all the time, and also here, that the state in which the output timings of the signals from the phase detection sensors 64 for the respective photosensitive drums 1 match each other is the desired phase relationship that can suppress the color deviation of AC components. In this embodiment, the stopping phases of the respective photosensitive drums 1C and 1K are assumed to be the same, and at the next activation of the photosensitive drums 1C and 1K, the motors 39C and 39K that are driving the photosensitive drums 1C and 1K are caused to have different speed profiles (hereinafter, referred to as “acceleration curves”), the speed profile being exhibited from the activation start to the steady-state speed during the activation. Note that, in this embodiment, the acceleration curve of the motor 39 is set as a straight line having a fixed inclination.

(Stopping and Activation of Photosensitive Drums)

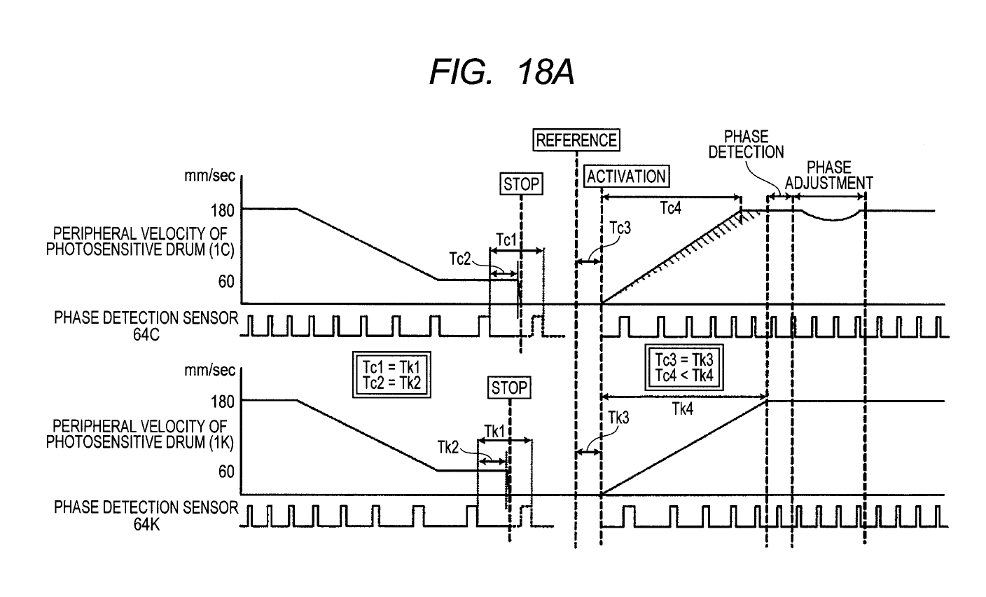

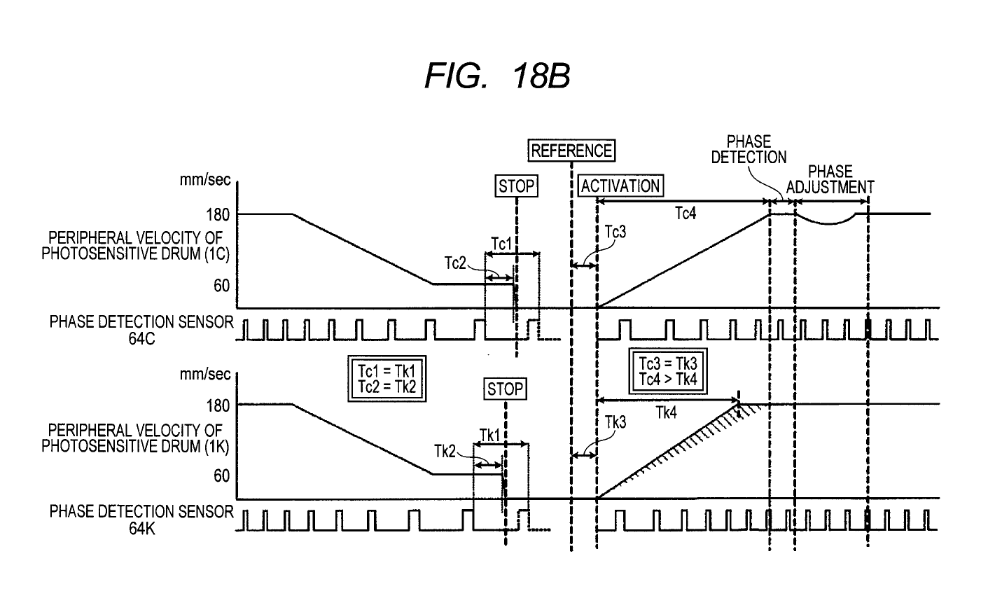

FIGS. 18A and 18B illustrate relationships between the peripheral velocities (mm/sec) of the photosensitive drums 1C and 1K and the output signals from the phase detection sensors 64C and 64K in cases of stopping and activating the photosensitive drums 1C and 1K, respectively. Note that, description thereof that has already been given with reference to FIG. 6 is omitted to avoid a duplicate. The phase relationship between the photosensitive drums 1C and 1K obtained when the CPU 40 reduces the peripheral velocities of the photosensitive drums 1C and 1K from 180 mm/sec down to 60 mm/sec (Tc1=Tk1) by the motors 39C and 39K is set to a predetermined positional relationship (phase relationship) in order to suppress the color deviation. Further, the timings (stop timings) at which the CPU 40 stops the photosensitive drums 1C and 1K by the motors 39C and 39K are set to have a relationship of Tc2=Tk2, and the phases of the respective photosensitive drums 1C and 1K are aligned when the photosensitive drums 1C and 1K are stopped. Then, when the CPU 40 performs the next activation of the respective photosensitive drums 1C and 1K by the motors 39C and 39K, the respective photosensitive drums 1C and 1K are activated at the activation timings Tc3 and Tk3 after the reference timing, respectively. The activation timings Tc3 and Tk3 satisfy a relationship of Tc3=Tk3. Further, the CPU 40 sets the acceleration curves of the motors 39C and 39K so as to cause the respective photosensitive drums 1C and 1K to reach the steady-state speed at timings Tc4 and Tk4 (msec) after the activation start, respectively. Then, the CPU 40 sets the values of the timings Tc4 and Tk4 so that the phase of the photosensitive drum 1C for color leads when the peripheral velocities of the respective photosensitive drums 1C and 1K driven by the motors 39C and 39K both reach the steady-state speed (180 (mm/sec)). In other words, in this embodiment, the CPU 40 activates the photosensitive drums 1C and 1K at the same timing (Tc3=Tk3), and controls the photosensitive drum 1C for color to reach the steady-state speed (180 (mm/sec)) earlier than the photosensitive drum 1K for black. By this control, it is possible to attain the state in which the phase of the photosensitive drum 1C for color leads when the photosensitive drum 1K for black reaches the steady-state speed (180 (mm/sec)).

Note that, FIG. 18A illustrates a case where Tc4<Tk4 is satisfied, and FIG. 18B illustrates a case where Tc4>Tk4 is satisfied. FIG. 18A and FIG. 18B illustrate two examples in which a relative rotation moving distance in one of the photosensitive drums is caused to differ from a relative rotation moving distance of the other photosensitive drum in order to create a relative phase difference between the photosensitive drum 1C and the photosensitive drum 1K from a state in which there is no relative phase difference therebetween.

Here, the following relationship is satisfied during a period after the CPU 40 activates the respective photosensitive drums 1C and 1K by the motors 39C and 39K until an arbitrary timing at which both the photosensitive drums 1C and 1K reach the steady-state rotation. Note that, during the period until the arbitrary timing at which both the photosensitive drums 1C and 1K reach the steady-state rotation, the total rotation moving distances by which the respective photosensitive drums 1C and 1K have been rotated are set as Xc and Xk (mm), respectively, and a peripheral length of the photosensitive drum is set as Y (mm).

Case of Xc>Xk (Tc4<Tk4)

Y×N<Xc−Xk<Y×(N+1/2) (N=integer≧0) (Expression 8)

(Expression 8) can also be expressed as 0<mod((Xc−Xk), Y(360°))<Y/2. Note that, mod(a, b) is the remainder obtained by dividing a by b. (Expression 8) indicates a case where the lead amount of the rotation phase of the photosensitive drum 1C with respect to the rotation phase of the photosensitive drum 1K is larger than 0° and smaller than 180° and a case where the lead amount is larger than 360° and smaller than 540°. Note that, a difference between the rotation moving distances Xc and Xk is determined depending on how large a difference between rotation drive distances of the respective photosensitive drums is to be created at the activation of the respective photosensitive drums.

Case of Xc<Xk (Tc4>Tk4)

Y×(N−1/2)<Xk−Xc<Y×N (N=integer≧0) (Expression 9)

(Expression 9) can also be expressed as Y/2<mod((Xk−Xc), Y(360°))<Y. (Expression 9) indicates a case where the lead amount of the rotation phase of the photosensitive drum 1C with respect to the rotation phase of the photosensitive drum 1K is larger than 180° and smaller than 360° and a case where the lead amount is larger than 540° and smaller than 720°.

The areas of the shaded portions of FIGS. 18A and 18B each indicate a difference between the rotation moving distances created during the period until the arbitrary timing at which both the photosensitive drums 1C and 1K reach the steady-state rotation, and each mean the phase difference between the photosensitive drums 1C and 1K. For example, in FIG. 18A, assuming that each of diameters of the respective photosensitive drums 1C and 1K is 30 (mm) and that each of peripheral velocities thereof is 180 (mm/sec), a state in which the photosensitive drum 1C leads the photosensitive drum 1K by a phase of 15 (deg) is attained as follows. That is, the state is achieved when the area of the shaded portion illustrated in FIG. 18A becomes peripheral length corresponding to the phase of 15 (deg) being the phase difference between the photosensitive drums 1C and 1K. That is, the state is achieved by setting the acceleration curves (Tc4 and Tk4) of the photosensitive drums 1C and 1K so as to satisfy Tk4−Tc4<43.63 (msec).

In the same manner as in the first embodiment and the fifth to seventh embodiments, the CPU 40 performs the phase detection and the phase adjustment when the peripheral velocities of the photosensitive drums 1C and 1K reach the steady-state speed. In FIGS. 18A and 18B of this embodiment, the phase of the photosensitive drum 1C leads (Ccnt<Kcnt), and hence it is basically unnecessary to perform the processing of S908 of FIG. 5 according to the first embodiment. Note that, for the same reason as in the second embodiment, the phase lead amount is set within the range from 0° to 180°. This is why (N+1/2) is on the right-hand side of the above-mentioned (Expression 8) and (N−1/2) is on the left-hand side of the above-mentioned (Expression 9). Then, if the flowchart of FIG. 5 is executed after performing the activation described with reference to FIG. 18A or 18B, the CPU 40 determines NO in S907. Then, the CPU 40 performs the control to reduce the rotation speed of the motor 39C that is driving the photosensitive drum 1C to thereby perform the phase adjustment.

As described above, according to this embodiment, it is possible to realize any one of the following: preventing operation noise of the motor 39 from increasing in the phase adjustment of the photosensitive drum 1; reducing consumption power; and achieving a reduction in the motor specifications.

Next, a ninth embodiment of the present invention is described. In the eighth embodiment, the acceleration curves of the motors 39 for driving the photosensitive drums 1C and 1K are each set as a straight line having a fixed inclination. In this embodiment, a case where the acceleration curve of the motor 39 does not have a fixed inclination is described. This embodiment is the same as the eighth embodiment in the other respects, and hence description thereof is omitted, while only components different from the eighth embodiment are described.

(Stopping and Activation of Photosensitive Drums)

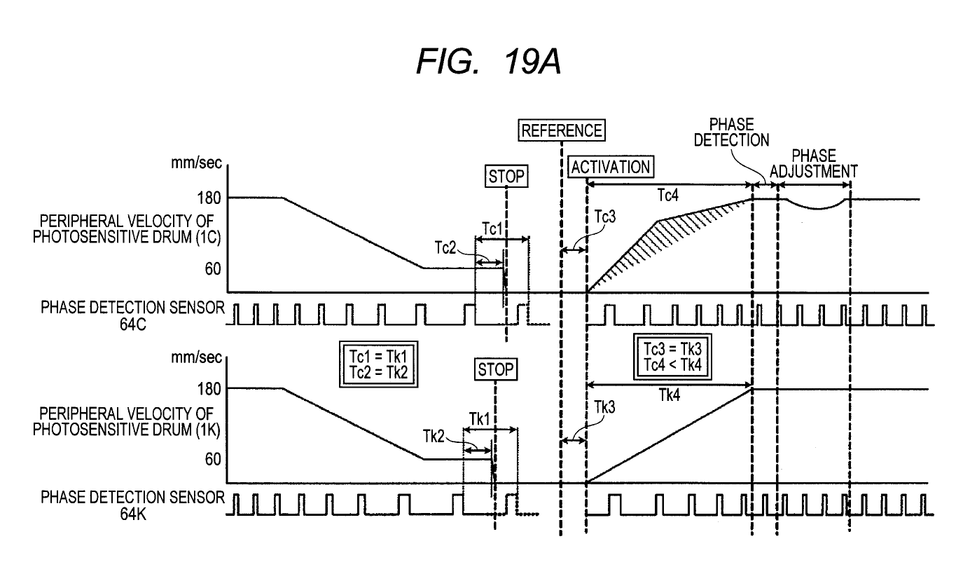

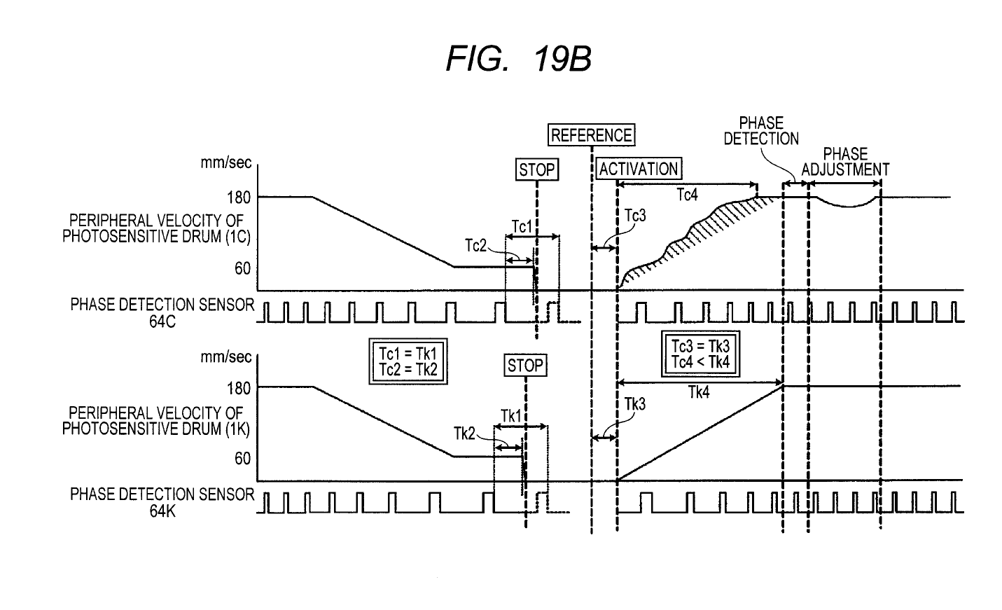

FIGS. 19A and 19B are referenced to describe actual operations according to this embodiment. FIG. 19A illustrates a configuration in which the acceleration curve of the photosensitive drum 1C is a straight line having two kinds of inclinations, and FIG. 19B illustrates a configuration in which the acceleration curve of the photosensitive drum 1C has an unevenly-changed inclination. In the same manner as in the eighth embodiment, this embodiment also produces the same effect as long as the areas of the shaded portions of FIGS. 19A and 19B (differences between Xc and Xk, in other words, phase differences) satisfy (Expression 8) or (Expression 9). Further, the acceleration curves exhibited from the activation start to the steady-state speed during the activation of the motors 39C and 39K that are driving the respective photosensitive drums 1C and 1K are not limited to the acceleration curves illustrated in FIGS. 19A and 19B, and the same effect can naturally be obtained as long as the relationship of (Expression 8) or (Expression 9) is satisfied.

As described above, according to this embodiment, it is possible to realize any one of the following: preventing operation noise of the motor 39 from increasing in the phase adjustment of the photosensitive drum 1; reducing consumption power; and achieving a reduction in the motor specifications.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-150104, filed Jun. 30, 2010, NO. 2011-020807, filed Feb. 2, 2011, and No. 2011-081948, filed Apr. 1, 2011, which are hereby incorporated by reference herein in their entirety.

What is claimed is:

1. An image forming apparatus, comprising:
a plurality of image bearing members;
motors that drive the plurality of image bearing members;
a detector that detects rotation phases of the plurality of the image bearing members;
a controller that starts driving the plurality of image bearing members according to a printing instruction from an external computer and performs phase adjustment for controlling rotations of said motors so that the rotation phases of the plurality of image bearing members achieves a predetermined phase relationship based on the detected rotation phases of the plurality of image bearing members during a period after the drive of the plurality of image bearing members is started and before an image forming operation is performed; and
an image forming unit that forms an image on each of the plurality of image bearing members based on image data transmitted from the external computer, after the phase adjustment is performed by the controller,
wherein based on a rotation phase of an image bearing member as a reference among the plurality of image bearing members whose rotation phase is detected by said detector and a rotation phase of another image bearing member except said image bearing member as the reference, the controller performs the phase adjustment to achieve the predetermined phase-relationship by reducing a rotation speed of a motor that drives the another image bearing member except said image bearing member, so that the image forming unit forms the image after the phase adjustment is finished.

2. An image forming apparatus according to claim 1, wherein the controller, in case of stopping said plurality of image bearing members, stops the plurality of image bearing members so as to attain a state in which the rotation phase of the another image bearing member leads the rotation phase of the image bearing member as the reference by a range from 0° to 180°, and
in case of activating said plurality of image bearing members, activates the plurality of image bearing members so as to maintain the state in which the rotation phase of the another image bearing member achieves the rotation phase of the image bearing member as the reference in the case where said motors rotates at a steady-state rotation speed used for image formation.

3. An image forming apparatus according to claim 1, wherein the controller, in case of stopping said plurality of image bearing members, the controller stops the plurality of image bearing members in a state in which the image bearing member as the reference and the another image bearing member match the rotation phases with each other, and
in case of activating said plurality of image bearing members, activates said plurality of image bearing members so as to attain a state in which the rotation phase of the another image bearing member leads the rotation phase of the image bearing member as the reference by a range from 0° to 180° in the case where said motors rotate at a steady-state rotation speed used for image formation.

4. An image forming apparatus according to claim 1, wherein said image forming apparatus is capable of performing image formation in a full-color mode for performing the image formation by said plurality of image bearing members and in a monochrome mode for performing the image formation by the image bearing member as the reference; and
wherein in a case where an image is formed in the full-color mode, said controller activates the image bearing member as the reference so as to attain a state in which the rotation phase of the another image bearing member leads the rotation phase of the image bearing member as the reference by a range from 0° to 180° in a case where said motors rotates at a steady-state rotation speed used for the image formation, based on a phase relationship between the rotation phase exhibited when the image bearing member as the reference is stopped after the image formation is performed in any one of the full-color mode and the monochrome mode and the rotation phase exhibited when the another image bearing member is stopped after the image formation is performed in the full-color mode.

5. An image forming apparatus according to claim 1, wherein the image bearing member as the reference is an image bearing member whose rotation phase is last detected among the plurality of image bearing members by the detector for detecting the rotation phases of the plurality of image bearing members.

6. An image forming apparatus according to claim 1, wherein the image bearing member as the reference is determined from among the plurality of image bearing members to prevent a phase amount to be adjusted by reducing the rotation speed of the motors that drives the another image bearing member from becoming the largest.

7. An image forming apparatus according to claim 1, further comprising:
a calculation unit that calculates a phase amount by reducing the rotation speed of said motors for driving the another image bearing member, in a case where the rotation phase is determined to be most delayed for each of the plurality of image bearing members; and
a determination unit that determines the image bearing member as the reference from among the plurality of image bearing members based on calculation results from the calculation unit to prevent at least the phase amount to be adjusted from becoming the largest.

8. An image forming apparatus according to claim 1, wherein in a case where the phase amount to be adjusted becomes smallest by reducing the rotation speed of said motors for driving the other image bearing member ranges within 0° to 270°.

9. An image forming apparatus according to claim 1, wherein a speed profile of the motor for driving the image bearing member as the reference is mutually different from speed profiles of said motors for driving the another image bearing member until a steady-state speed is reached after activation of said motors.
